(19) United States
(12) Patent Application Publication
(10) Pub. No.: US 2003/0036994 A1
(43) Pub. Date: Feb. 20, 2003

(54) Automated mortgage lender processing system

(76) Inventors: Brad Witzig, Centennial, CO (US); Todd Sherman, Aurora, CO (US)

Correspondence Address: The Law Offices of William W. Cochran, LLC, 3555 Stanford Road, Suite 230, Fort Collins, CO, 80525, US

(21) Appl. No.: 10/123,075

(22) Filed: Apr. 12, 2002

Related U.S. Application Data
(60) Provisional application No. 60/283,660, filed on Apr. 12, 2001.

(51) Int. Cl. G06F 17/60

(52) U.S. Cl. 705/38

(57) ABSTRACT

A loan processing method and system is disclosed that includes a database containing task descriptions, status, and rules information. In response to data entered to the database, status information is assigned to tasks and tasks are assigned to work departments or individuals using rules information. Tasks may also comprise automated portions that may retrieve or disseminate information electronically. Users may update status as tasks are completed, resulting in a new status and new task assignments. A tickler program alerts users of messages and status conditions. Data formatting allows data entry from or data output to third party software. A client portion of the invention employs a windowed architecture where software modules provide display and operational functions. Software modules may be added or deleted without recompiling client software. Administrative software provides control of client software by user type and function plus allows upgrade, maintenance and backup of system components.

### CROSS REFERENCE TO RELATED APPLICATIONS

This application claims the benefit of U.S. patent application Ser. No. 60/283,660 entitled “Automated Mortgage Lender Processing System”, filed Apr. 12, 2001 by Brad Witzig and Todd Sherman, the entire disclosure of which is herein specifically incorporated by reference for all that it discloses and teaches.

### BACKGROUND OF THE INVENTION

a. Field of Invention

The present invention pertains generally to computer programs and more specifically to computer programs that provide an automated processing system for mortgage loans.

b. Description of the Background

The process of ordering and securing a loan, such as a mortgage loan on real estate, can be a complex and involved process. There are many steps that need to be taken to secure loans. For example, typical mortgage lending institutions have various departments for processing various aspects of the loan. One department may run credit checks while another department may establish employment records and bank deposits. Another department may work with funding sources to establish interest rates, discount points, and other aspects of the loan. All of these functions must be coordinated and the information obtained in an organized fashion in order to close loans in a reasonable time period. The coordination of this effort is somewhat complex, especially in view of changing conditions, such as changing interest rates.

In a very competitive lending market, it is desirable to be able to provide a loan within a fixed time period and be able to guarantee that loan at a specific interest rate. If all of the complex steps cannot be completed within a short time, the ability to place a loan within that time period may not be possible. Further, the ability to set a very short predetermined time period to place a loan may significantly affect the ability to sell loans.

Additionally, the current processing flow of loan applications involves having a loan officer who is responsible for originating a loan and a number of people who are responsible for processing the loan through and after closing. Current processes require telephone calls, faxes, and other types of communication between the various departments of the mortgage lender's office. Such a system is inefficient and inexact due to lack of proper organization.

It would therefore be useful to have an automated system which is capable of organizing tasks that must be completed by various departments and would allow these tasks to be assigned automatically and processed in parallel to reduce the overall processing time. In addition, it would be advantageous to have a system that keeps track of all of the tasks that need to be performed and requires the necessary steps to be followed in various sequences to enable completion of the processing.

### SUMMARY OF THE INVENTION

The present invention overcomes the disadvantages and limitations of the prior art by providing an automated mortgage loan processing and loan management system for mortgage bankers, lenders, and brokers, and their respective clients. The system guides the mortgage company through all of the necessary steps and processes required to process and close a loan. The system includes loan origination capability and is also capable of importing from and exporting to other standard loan origination software packages that are used to originate loans. For example, standard origination software packages allow entry of information such as name, address, income, financial history, credit history, and other types of data. The present invention includes a software module that can import the loan origination software package data and transfer this data into various fields of the software package of the present invention. Each of the loans is then placed in a queue and made available for processing.

The present invention may therefore comprise a system for processing loans comprising: a database containing loan information and plurality of task descriptions, a plurality of first software programs, each providing a function associated with processing a loan, a second software program operable to detect a variable contained in one of the plurality of first software programs and transfer one of the plurality of task descriptions to the one of the first plurality of software programs based on the value of the variable.

The system dynamically defines all of the tasks that are determined by the mortgage lender and assigns each of these tasks to different departments. Each of these tasks can then be performed in parallel with responsibility transferred to each of the departments, such as the rate lock department, and the underwriting department, for example.

The invention may additionally comprise a method for processing a loan employing a database containing a plurality of tasks and a set of rules associated with processing a mortgage loan comprising: receiving mortgage loan status information, accessing the database containing the plurality of tasks and the set of rules, employing the set of rules to associate the status information with at least one task of the plurality of tasks, and assigning the at least one task to a user.

The invention may further comprise a method for processing a loan employing a database containing task descriptions comprising: entering loan information into the database, assigning a first task in response to the loan information, assigning a status value to the first task, performing the first task, changing the status value in response to user input, and assigning a second task in response to the change in the status value.

Further, the present invention includes an archival audit trail that is capable of tracing any changes that have been made during the loan process. Each individual who enters data into the system is identified. For example, if a loan rate or a discount point is changed, a record is made as to when that change was made and who made the change. In this manner, complete and accurate records can be kept in the form of an audit trail to insure that improper actions are not taken during the loan process. Further, responsible parties can be identified as to whether information is being obtained within targeted time periods so that the loan can be processed in a quick and accurate fashion.

The present invention provides a dynamic, or user-driven, loan entry system comprising loan entry forms with a choice of data entry preferences and loan compliance forms with a choice of data entry preferences. The present invention may also provide loan entry software wizards for creating forms, calculating rates, and importing and exporting third-party loan documents.

Additionally, the present invention provides a tickler system comprised of an event-driven escalation and notification process for the mortgage lending company. The tickler system helps prevent oversights and delays from being made during processing.

Further, the present invention may be used over the Internet. Internet networking permits mortgage lenders to access live data on loans while traveling or at home. Data traveling over the Internet may be accessed through a secure HTTPS web site with 128 bit encryption and SSL (secure sockets layer), for example. The present invention may be implemented using servers, network equipment and client computers common to business.

The present invention may further yet comprise an automated loan processing system comprising: a database containing loan information, a plurality of loan processing tasks, status information and a set of rules, a client software program comprising at least one software module that may be dynamically loaded, a server loan processing software program operable to apply the set of rules to the status information to assign at least one task of the plurality of loan processing tasks to a user; and a network connection that provides communication between the server and a client computer

### BRIEF DESCRIPTION OF THE DRAWINGS

FIG. 1 is a schematic diagram of the manner in which the present invention can be implemented using the Internet.

FIG. 2 is a schematic diagram illustrating the use of multiple child forms.

FIG. 3 is a schematic flow diagram of the manner in which status, tasks, and parameters are used to manage the loan management process.

FIG. 4 is a more detailed schematic block diagram illustrating the manner in which the present invention operates.

FIG. 5 provides an example of operation of the software engine of the present invention.

FIG. 6 is a depiction of an upfront screen that is displayed when a user logs on.

FIG. 7 is a depiction of the loan entry screen of the present invention.

FIG. 8 is a depiction of a work queue screen showing one active loan in the task queue.

FIG. 9 is a depiction of a milestone screen showing pending tasks and status associated with a loan.

FIG. 10 depicts an underwriting conditions screen.

FIG. 11 depicts a rate lock screen.

FIG. 12 depicts a tickler screen showing changes in loan data and pending critical dates.

FIG. 13 is a depiction of an attachments screen.

FIG. 14 is a depiction of a comments screen.

FIG. 15 depicts an item tracking screen.

FIG. 16 depicts a secondary screen containing investor information

FIG. 17 depicts a hedging screen.

FIG. 18 depicts a reporting screen.

FIG. 19 depicts a production graph screen.

FIG. 20 is a depiction of a screen containing information for the government Housing Mortgage Disclosure Act (HMDA).

FIG. 21 depicts an administration screen.

FIG. 22 is a depiction of an LOS administration screen.

FIG. 23 depicts a system screen

FIG. 24 depicts a data dictionary screen.

FIG. 25 depicts one embodiment of task assignment.

### DETAILED DESCRIPTION OF THE PREFERRED EMBODIMENT OF THE INVENTION

a. Overall Description of the Invention

In general, the present invention provides a workflow system that automates mortgage loan processing. A software engine controls the various module functions throughout the loan management process. The engine may be batch oriented or may be event driven. For example, if any field in the database changes, the change prompts the engine to send messages to the loan officer and the underwriting department. When tasks are completed, the engine enables the milestone module to prompt for a status change, further advancing the loan towards closing. The engine of the present invention manages a network of customizable loan management modules. The present invention may be implemented as a software system through Intranet and Internet connections.

The present invention may include loan origination software. A loan officer may enter loan data into the loan origination software package when meeting or discussing a loan with the borrower. The mortgage lender is presented with a choice of data entry formats for loan applications and compliance forms, which include:

1. Screen Entry—Enter data on customizable standard entry screen.

2. Form Entry—Enter data directly onto a visual form-so-called visual entry.

3. Wizard Entry—Step-by-step screens guide the user through a process.

Alternately, this information may be automatically entered by the borrower through Internet connection to the mortgage lender. Borrower entered information may include the name and address of the borrower, income, employment history, credit history, and other types of information necessary to originate a loan, as outlined on a 1003 standard loan application form. A loan officer may concurrently order a credit report or the software may be configured to automatically run a credit report once authorized by the borrower through submitting the loan application. Credit reporting data from the credit report enters directly into the loan origination software package.

The present invention may import and export third-party loan origination software information. As such, data from the loan origination software may be transferred through an interface into the database system of the present invention. The software program of the present invention automatically determines if sufficient fields of information are complete and provides that information to the loan officer. The present invention processes the data set that has been entered to originate the loan and provides an interactive graphic user interface that is presented to loan processors and other individuals of the mortgage lender.

Each of the departments has access to one or more software modules, that may be customized, that are controlled by the software engine that communicates with a database where loan information is stored. Loan information is distributed as needed to each of the modules in each of the different departments, allowing data to be processed in parallel for each of the tasks that are assigned to each of the departments. In addition, the manager of a particular department and the general manager may customize the modules and the overall program, respectively, to create the desired logic trees for processing the data. Hence, each mortgage lender can easily and automatically establish the criteria for which loans can be made.

The Work Queue module of the present invention maps the path each loan will take through the loan management system, tracks the time each loan is in a particular department, allows the user to search for a loan based on any field in the database, and may customize the loan views for each department. The system of the present invention automatically assigns, in a logical sequence, corresponding tasks to the various departments of the mortgage lender's office for completion of those tasks. Tasks may be distributed to departments or to individuals. Responsibility for completion of those tasks then passes to individuals within each of the departments. In contrast to having a manual process of completing all of the tasks that are associated with closing a loan, the system of the present invention dynamically defines all of the tasks that are predetermined and assigns them to various departments and various individuals within those departments. In this manner, all of the different tasks that are necessary to complete the loan may be processed in parallel.

The software system of the present invention provides a milestone module that, when a particular loan is selected, lists a series of outstanding tasks that are to be completed. As each task or event is completed, the milestone module verifies the event or task against pre-designated loan completion criteria previously entered in the work queue module of the present invention. When pre-designated criteria have been met for each individual or department, the milestone module, through the software engine, launches a status change, to be completed either automatically or manually, through the change status wizard. Event-driven status changing, simple user driven status changing, or a combination of both can be used to change the status of the loan, moving it through the user queues.

As indicated above, parallel processing of the various tasks through different departments of the mortgage lender, in an organized fashion, decreases the time necessary to process the loan. For example, a loan officer might request a rate lock at the same time that the loan is originated. In this fashion, a completion date for closing the loan can be managed so that the loan may be closed more quickly and efficiently than with current methods and thus increase a mortgage company's productivity and profit. In addition, the present invention enables the loan to be closed within the time period of a rate lock that has been set for a particular loan. If a rate lock has been missed because of a failure to process the loan within the required period, the mortgage lender may be responsible for the difference in those rates, which may be very costly to the mortgage lender. As a result of the parallel processing of the loan that may be performed using the present invention, a shortened window from the time of loan application to closure of the loan may be achieved.

The software system of the present invention includes a rate locking module and a secondary module. Loan rate and investor information are tracked through these modules. Optionally, the rate lock module allows the secondary department to manage locks. The present invention may provide a rate lock wizard that allows a user to request a lock. The secondary department may approve locks and automatically send lock confirmation through the tickler system. A lock request history is kept on each loan. Rate locks may be automated, dependent on pre-set parameters.

The present invention allows the underwriting department to directly interface with lenders who may review the origination information such as income, loan-to-value ratios, credit history, employment history, and other factors to determine if a borrower may qualify for the requested rate. The underwriting department may also verify the 1003 form information, income verifications, copies of W-2s, copies of tax returns, and other information that has been provided. Since this information is directly and immediately transferred to the secondary marketing department, that information may be provided quickly and in an automated fashion, without requiring phone calls, faxes, or other types of communication. Simultaneously, and in parallel, the secondary marketing department may check the loan information entered by the loan officer and solicit appropriate lenders. The loan officer may then provide the borrower with an acceptance at the requested rate lock or a denial with a suggested alternative rate lock.

The system of the present invention may include a customizable tickler system module that provides for escalation and notification. The tickler system module informs key personnel of upcoming events, critical loan field modifications, comments, other system or loan warnings, and user-created reminders. By alerting loan processors of delays or changes, the tickler module of the present invention may further reduces loan-processing time. The tickler system helps to prevent steps from being missed and allows managers to easily control decisions that are made during processing of the loan.

The system may also be implemented such that interconnections to the Internet allow for extraction of data from different web sites, such as credit reporting agencies or flood certification companies, for example, to automatically download pertinent data into the loan management system. A loan may also be initiated by the loan officer at a client station, at a remote location, or on a portable version of the present invention and, through the Internet, initiate loan processing. Information such as name, address, social security number, and date of birth may be used to start the loan process. This information may be automatically transmitted from the remote location to a server that then accesses selected web site databases to obtain a complete loan package in an automated fashion.

In addition, smaller lenders, that may not want to make the investment in computer systems and software, may load a client portion of the software package of the present invention on a personal computer. Through the Internet or a managed IP network, the client portion of the software package may access processing and database elements of the present invention. When a client portion of the software package is utilized in this fashion, a fee may be charged for each loan that is originated and each loan that is closed. Database elements may be centralized at one location or may be distributed among multiple locations.

The software of the present invention stores archival information that provides an audit trail for determining each of the steps that has been taken and identifies the individuals, departments, times and dates on which these actions were taken. For example, if a rate change has been authorized by a particular individual, a record is made of that change so that managers and others in the mortgage lender office can determine who made the change. The archival records provide quality assurance by allowing analysis of data records for determining the various actions that have been taken by various individuals. In this fashion, mistakes or poor judgment on the part of employees during the process of completing loans can be identified by managers to minimize risk. For example, mortgage lenders may engage in hedging in order to maximize profits. The various decisions that have been made and the time and dates regarding those decisions may be analyzed to ensure that proper procedures for hedging were used to minimize risk.

b. Description of the Invention with Respect to the Figures

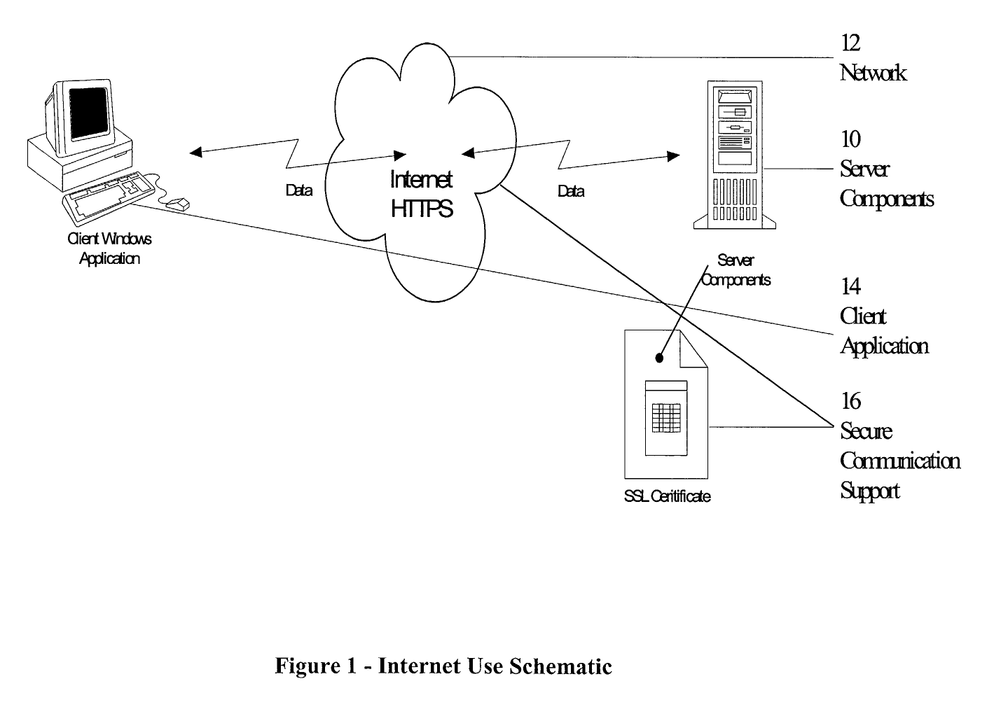

FIG. 1 is a schematic diagram of the manner in which the present invention can be implemented using the Internet. The invention may also be implemented using other networks. FIG. 1 illustrates the manner in which server components 10, network 12, and client application 14 are connected. Server components 10 may also include secure communication support 16 for secure communication with the client application 14. Secure communication support 16 may employ SSL (Secured Socket Layer) or other secure protocols. SSL is a protocol for transmitting private documents via the Internet. SSL works by using a private key to encrypt data that is transferred over the SSL connection. Many Web sites use the protocol to obtain confidential user information, such as credit card numbers. Server components 10 can span multiple or one physical server.

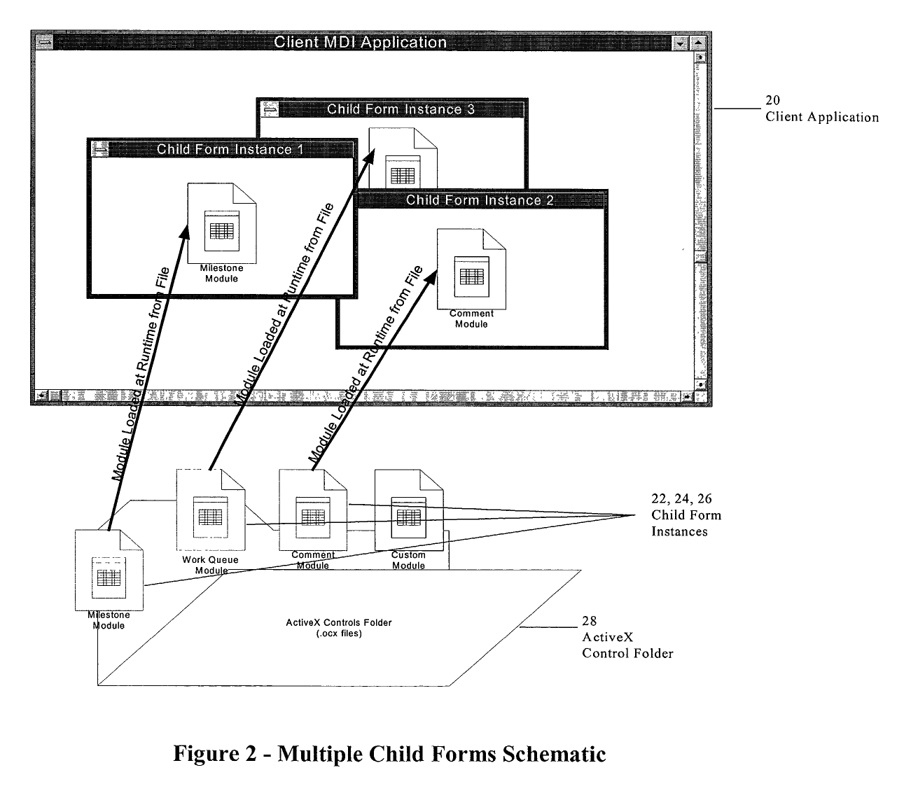

FIG. 2 is a schematic diagram illustrating the use of multiple child forms. Client application 20 supports child form instances. Each module is dynamically loaded into an instance of the child form. Client application 20 may, for example, be a Windows MDI (Multiple Document Interface) application. MDI is a Windows API (application programming interface) that enables programmers to easily create applications with multiple windows. Each MDI application has a single main window, and any number of child windows. All child windows are displayed within the main window.

Referring to FIG. 2, Child form instance 22 contains elements of a milestone module. Child form instance 24 contains elements of a comment module. Child form instance 26 contains elements of a Work Queue module. Child form instances may contain different modules, depending on the order in which they are loaded. The present invention supports different user types, such as loan originator, loan processor, or underwriter, for example. A different set of modules may be loaded depending on user type. The client application 20 supports dynamic loading of module interface elements at runtime. These module interface elements may comprise formats such as ActiveX. ActiveX is a set of programming rules that allow applications such as spreadsheets and word processors to be viewed in web browser formats. In the preferred embodiment, an ActiveX controls folder 28 contains .ocx files that are dynamically loaded at runtime. Additional files may be added to controls folder 28 to provide new functions. A benefit of the invention is that functions may be added, modified, or deleted without recompiling client software.

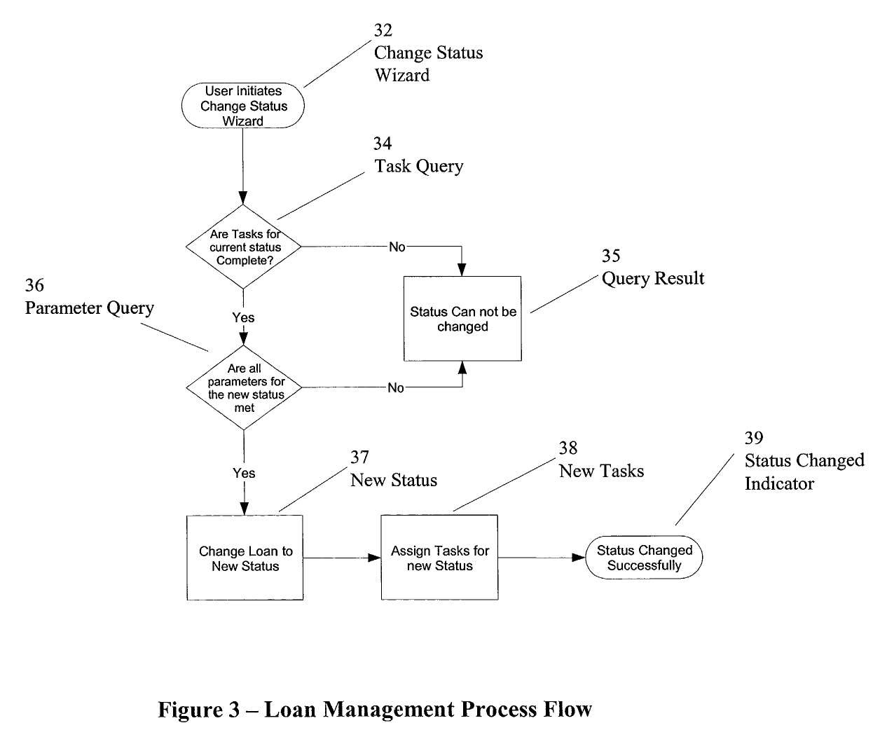

FIG. 3 is a schematic flow diagram of the manner in which status, tasks, and parameters are used to manage the work flow process. Parameters are rules, based on any field, that are enforced by the system. For example, a parameter may specify that loan value must be less than 80% of property value. The conditions defined by the parameter must be met before status associated with that parameter can be changed. The present invention allows the relationship in which status, tasks, and parameters control the work flow process that is defined by individuals with access privilege. For example, an administrator may define the individuals or departments to which tasks are assigned and the nature of those tasks. FIG. 3 depicts how completion of tasks may change the status of the loan. If the tasks associated with a particular status are completed, a new status is assigned to the loan that then results in the assignment of new tasks. In FIG. 3, the user initiates change status wizard 32 that enables task query 34. Task query 34 checks if tasks for the current status are complete. If the tasks for the current status are not complete, result 35 is produced such that the status cannot be changed. If the tasks for the current status are complete, query 36 is activated and a check is performed to see if all parameters for the new status are met. If all parameters for the new status are not met, result 35 is produced such that the status cannot be changed. If it is determined that all parameters for the new status are met, the process proceeds to step 37 to change the loan status to a new status. The process then proceeds to step 38 to assign new tasks for the new status. Upon completion of step 38, the process proceeds to step 39 to indicate that status has been successfully changed.

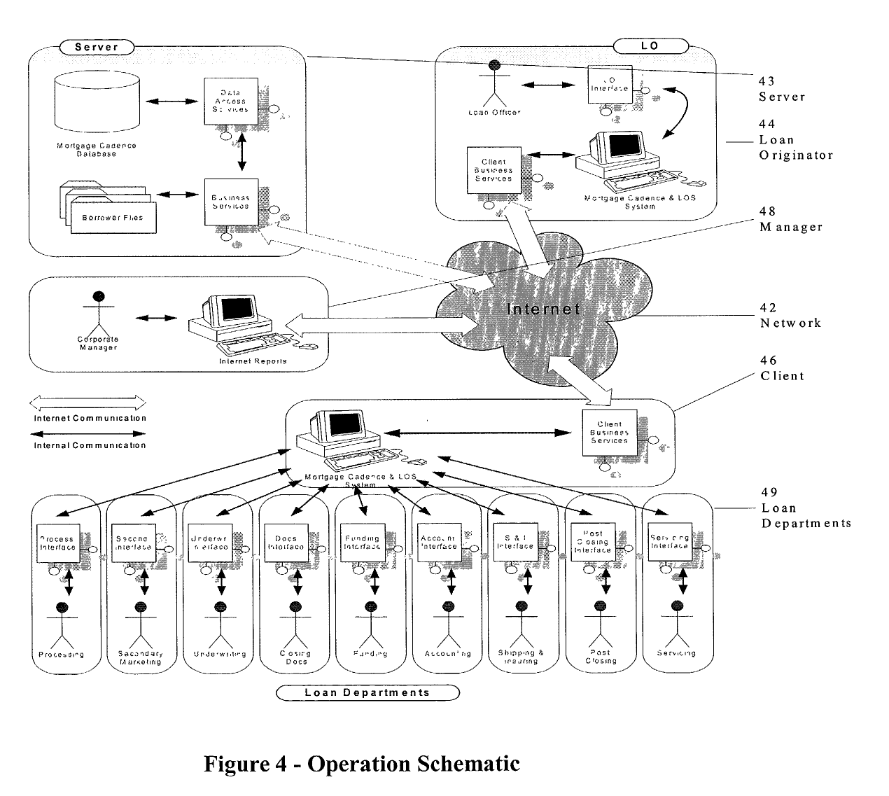

FIG. 4 is a more detailed schematic block diagram illustrating the manner in which the present invention operates. Referring to FIG. 4, network 42 provides communication between server 43, loan originator 44, client 46, and manager 48. Client 46 also provides services to loan departments 49. While FIG. 4 depicts a single example of the implementation of various elements, typical implementation of the invention would employ a variety of these elements. Network 42 may employ various protocols and may be an Internet, LAN, dial-up or other type of network. Multiple protocols may be supported simultaneously. For example, loan originator 44 may employ an Internet connection and client 46 may employ a LAN connection.

As noted in FIG. 1, server 43 may span multiple servers or one physical server. Business and data access components may exist separately. Server 43 stores task, status, and parameter information associated with the processing of a loan. Server 43 may also contain software for client 46, allowing downloading of updates and/or new functions. Manager 48 may access data and reports and view other aspects of system operation.

Again referring to FIG. 4, client software 46 provides tasks and status information to loan departments 49. The loan departments 49 typically employ a number of individuals assigned to perform different sets of tasks associated with the processing of a loan. A typical implementation of the invention comprises multiple instances of client 46, with each instance tailored to perform some or all of the available functions of the invention.

The functions provided to loan departments 49 are realized through a set of software modules. The present invention includes a predetermined set of modules. An administrator determines the modules that are used by various loan departments. Modules may be modified and new modules may be created to meet the needs of the various departments.

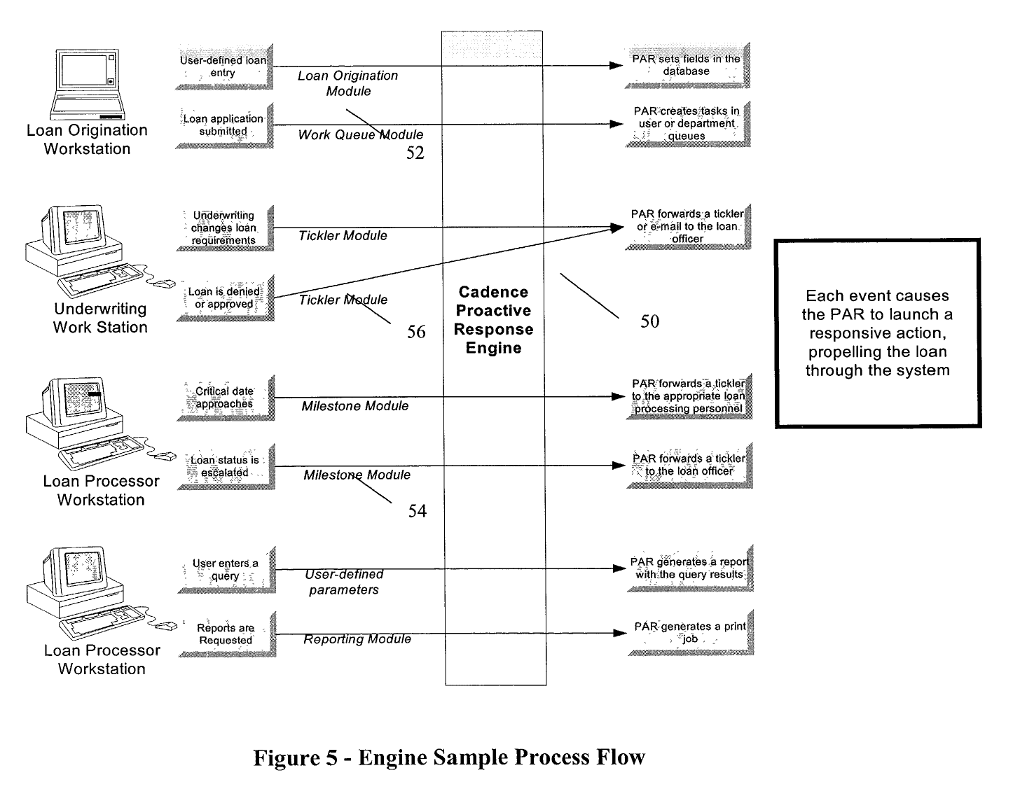

FIG. 5 provides an example of operation of the software engine of the present invention. Software engine 50 coordinates the transfer of information between modules and the database of the invention. A transfer of information may be in response to entered or retrieved data, status information, requests, or events such as time and date, for example. In response to loan application submission, software engine 50 creates tasks in user or department queues in work queue module 52. Tasks and dates associated with an individual loan may be viewed in milestone module 54. Tasks may include acquisition of information. For example, if credit and employment information have been received, the loan status may be escalated, resulting in software engine 50 forwarding a tickler message to a loan officer. A change in status, such as a loan being approved or denied, may result in tickler module 56 sending a message to a loan officer. The software engine 50 of the present invention may be event driven such that a change in a variable results in an action being performed. The software engine may execute tasks associated with modules in a specific order. If a plurality of loans is being processed, the software of the present invention may perform tasks for each loan associated with one software module at one time and then perform tasks for another software module, or the software may perform tasks associated with a first loan and then perform tasks associated with another loan. In other words, processing may be organized by module or by loan.

c. Description of the Invention with Respect to Screen Depictions

The following figures are screen shots which depict a displayed image as might be viewed on a display monitor or laptop screen employing the client device, of the present invention, that interacts with the server device. Description of these figures illustrates the functionality of various modules plus the flexibility and capability of the invention to provide simple and efficient processing of loans.

Operation of the present invention may be understood through the following description of events that may occur when processing a loan, starting with a loan originator requesting a new loan. The loan request may be performed through the loan origination capabilities of the present invention or third party loan origination software (LOS) products may be used. The loan originator runs the client software of the present invention on his or her computer. The present invention provides data handling to support the different data formats of the various LOS products. The loan originator may supply partial information, such as borrower name, address of the property and loan amount. When the loan originator 44 (FIG. 4) submits a loan request, the client software 46 (FIG. 4) processes the information from the LOS product and creates an output file that is communicated to the server 43 (FIG. 4). The server 43 receives the data, processes the data, creates a server database entry, and then provides a loan number to loan originator 44. There may be more than one loan number associated with a loan. The loan originator 44 may have a loan number that is in accordance with numbering systems used by his or her company or department. There may also be a mortgage identification number (MIN) having a format that corresponds to a national standard. The data base entry comprises status, task, and parameter information. From the data base entry, the invention assigns tasks to different mortgage company departments or individuals by function. Such tasks include obtaining any information that is missing from the loan application. A system administrator using the present invention may define the nature of the tasks and the departments to which these tasks are assigned, plus parameters associated with tasks and/or status. Loan entry activities employ software modules, including the loan entry module that provides the ability to add a new loan, the ability to interact with and import and export data from multiple LOS software systems, and the ability to generate loan numbers. The loan module also provides auditing of loan fields and check-in over an existing loan with escalation. Check-in, check-out and escalation are described in more detail below.

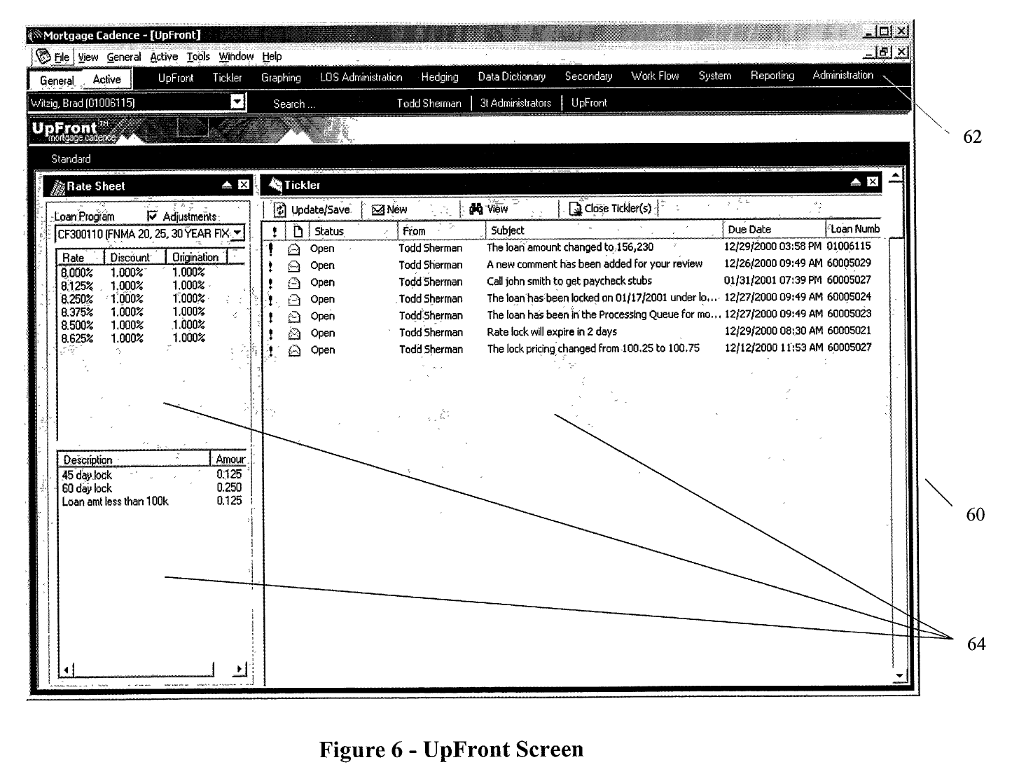

An individual working at the mortgage company employing the present invention to process a loan would first log on to the system. FIG. 6 depicts the upfront screen 60 of the user interface that is displayed when an individual logs on to the system of the invention. The navigation bar 62 allows the user to select different screen and information modes. The items displayed in the navigation bar 62 correspond to modules loaded at runtime that the user can access based on the level of permission for that user. The navigation bar 62 is displayed with all screen modes and allows the user to switch from one screen to another. The upfront screen information areas 64 may contain messages, comments, and pull down menus to access available features. The upfront screen may be customized by the user. Different sections may be added, such as opened ticklers, pipeline totals, my totals (user defined information such as loans closed), market conditions, rate sheet, company news, and loan tasks for example. These sections are described below. When a user logs on, the client application 46 (FIG. 4) of the present invention checks the version number of the client 46 (FIG. 4) and of the software modules. If the version of the client application 46 (FIG. 4) or the version of a software module is not the most recent version, the client application or software module is downloaded from server 43 (FIG. 4) and may be automatically updated.

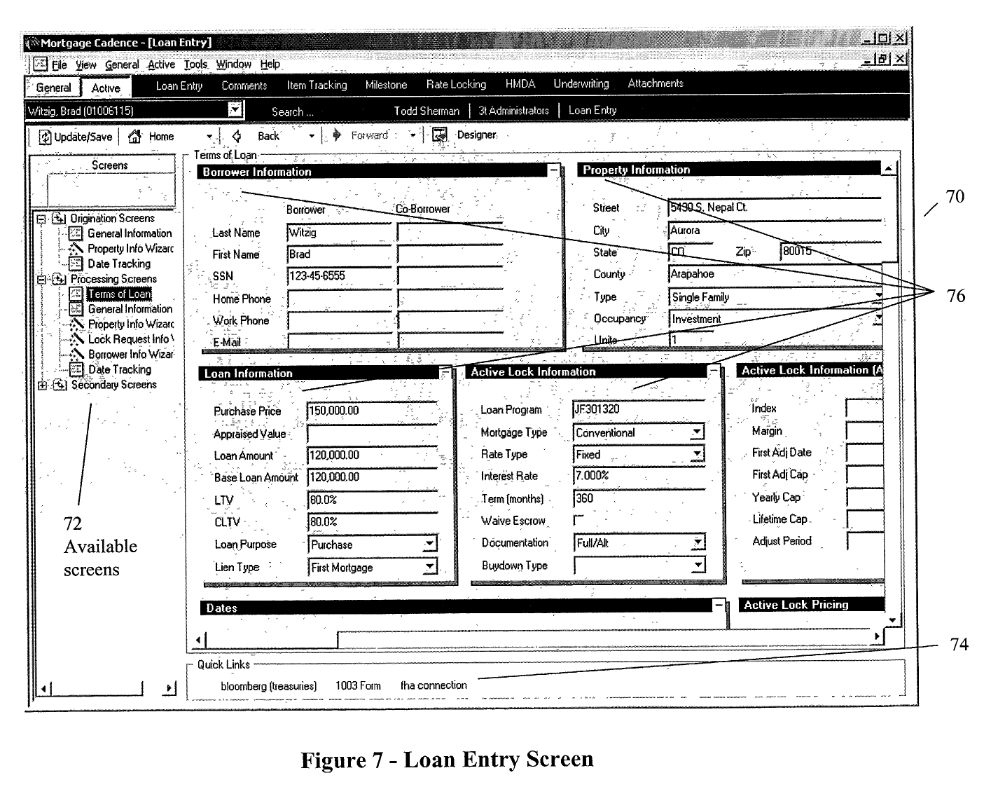

FIG. 7 is a depiction of the loan entry screen 70 of the present invention. All loan entry is done through this module. A list 72 of loan entry screens and wizards is found on the left side of the loan entry screen. Quick links 74 to applicable Internet sites for Treasury rates, FHA, or a traditional 1003 Form are located at the bottom of this screen. The screen shown in FIG. 7 shows the terms of the current loan 76, comprising borrower information, property information, loan information, and active rate lock information. Users may customize the entry process to meet their preferences, or use the loan entry screens provided. Users may create new fields in the database and build screens associated with the new fields. The loan entry module of the present invention includes three options for loan entry: (1) Screen Entry—Enter data on the customizable standard entry screens, (2) Form Entry—Enter data directly onto a visual form, so-called visual entry, and (3) Wizard Entry—step-by-step screens guide the user through a process.

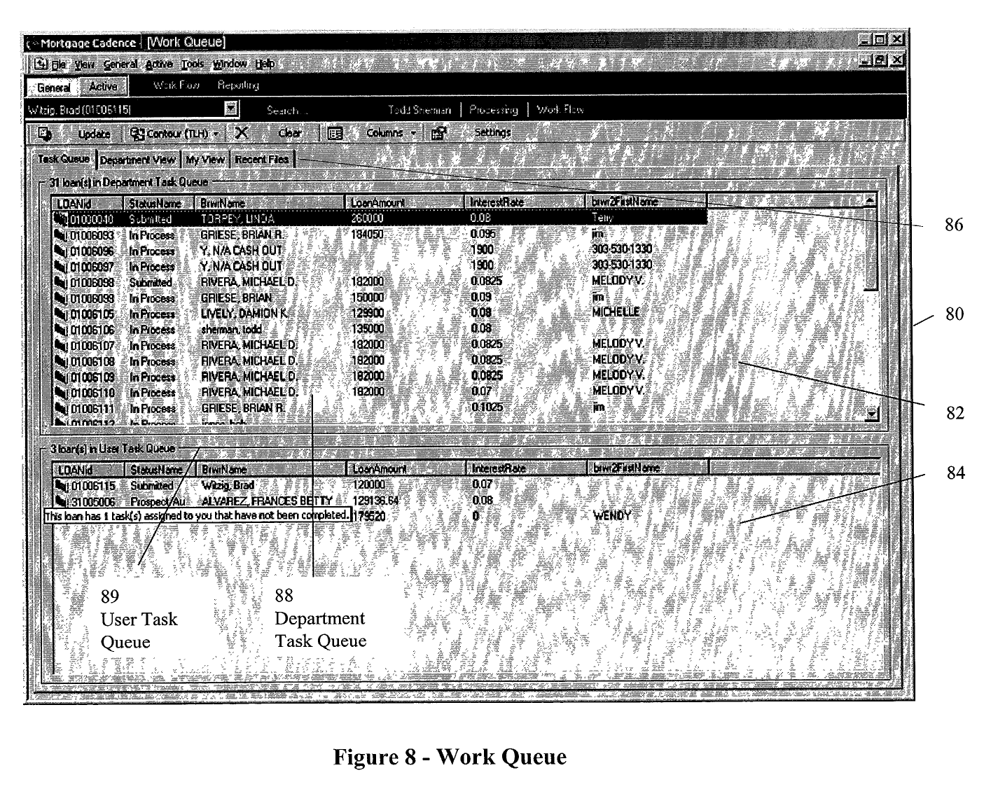

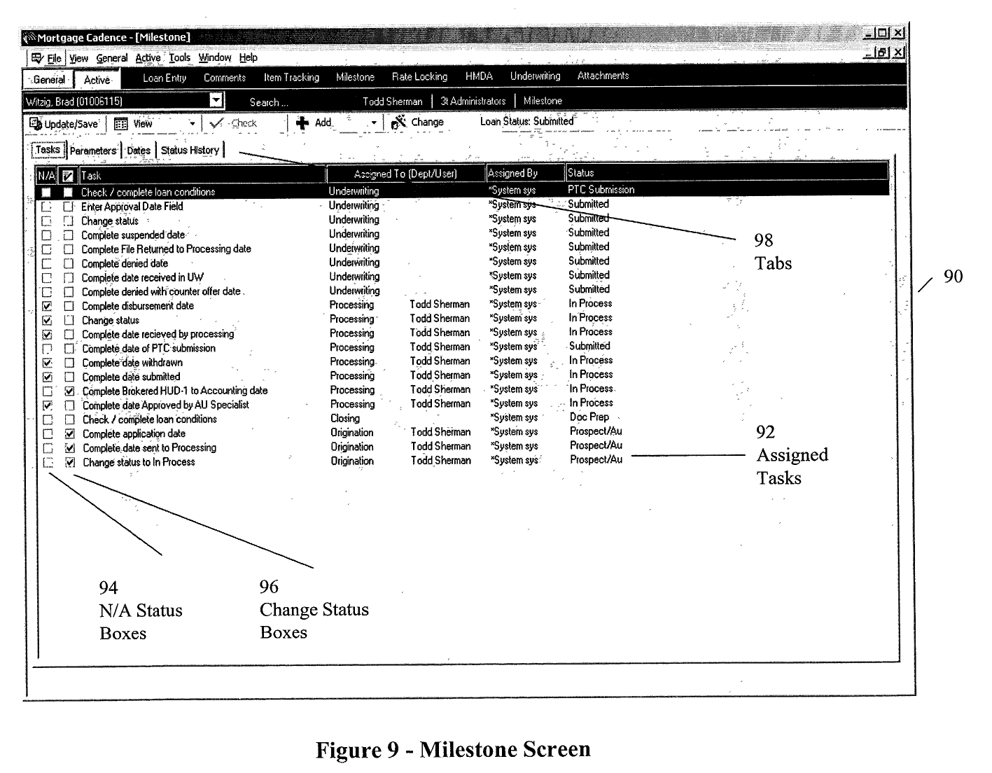

FIG. 8 is a depiction of the work queue screen 80 that a loan originator may view in processing a loan request. The work queue screen 80 of FIG. 8 depicts tabs 86 which are ‘task queue’, ‘department view’, my view‘, and ‘recent files’. In this figure, the ‘task queue’ tab is active and results in the following items. First display area 82 shows the department task queue 88, and second display area 84 shows the user task queue 89, containing three active loans. The contents of the department task queue 88 and the user task queue 89 vary depending on the user type, the user department, the number of loans, and the status, tasks, and parameters associated with the loans. The department task queue contains loans that require some action for processing. The user may select a loan in the department task queue and move it to the user task queue, thereby taking responsibility to perform tasks associated with that loan. Note that the actual tasks associated with the loan may be viewed in the milestone screen that is described in FIG. 9. The capabilities of the work queue screen 80 are controlled by the work queue module. If the ‘department view’ tab is selected from tabs 86, the user may view loans for that department based on some criteria, such as loans that have closed in the last 14 days. If the ‘my view’ is selected from tabs 86, the user may view loans that they have accepted responsibility for processing and which may be based on some criteria, such as FHA loans, for example. If the ‘recent files’ tab is selected from tabs 86, the user may view recently processed loans

FIG. 9 is a depiction of the milestone screen 90 showing tabs 98 that comprise a ‘tasks’ tab, a ‘parameters’ tab, a ‘dates’ tab and a ‘status history’ tab. The figure further depicts items displayed when the ‘task’ tab is active and shows pending tasks and status associated with a loan. The screen contains eleven assigned tasks 92 that are assigned to Todd Sherman. Todd Sherman works in both origination and processing departments. Status ‘N/A’ boxes 94 are checked for some tasks, indicating that Todd Sherman is responsible only for unchecked tasks at this time. The milestone screen is where the user may update task status. Change status boxes 96 may be checked when the associated task is complete with task updates operating as described in FIG. 3. The invention keeps track of which user checked boxes and changed status in the event that an audit of the processing is desired. The invention may use the change in status to assign a new set of tasks. The milestone module controls items displayed in the milestone screen. If the user selects the ‘parameters’ tab from tabs 98, the parameters for the loan are displayed. Parameters include conditions that must be met, such as the loan not being more that 80% of the value of the property, for example. If the user selects the ‘dates’ tab from tabs 98, the dates associated with loans are displayed. These may include duration of a rate lock and projected dates such as closing. If the user selects the ‘status history’ tab from tabs 98, a history of when status was changed is displayed.

The present invention also includes functions that provide information and processing options to the loan processor. For example, there may be several types of loans for which a borrower may qualify. There may also be different profit associated with different types of loans. Additionally, there may be different time periods required to process different types of loans, affecting when a buyer may close on a property.

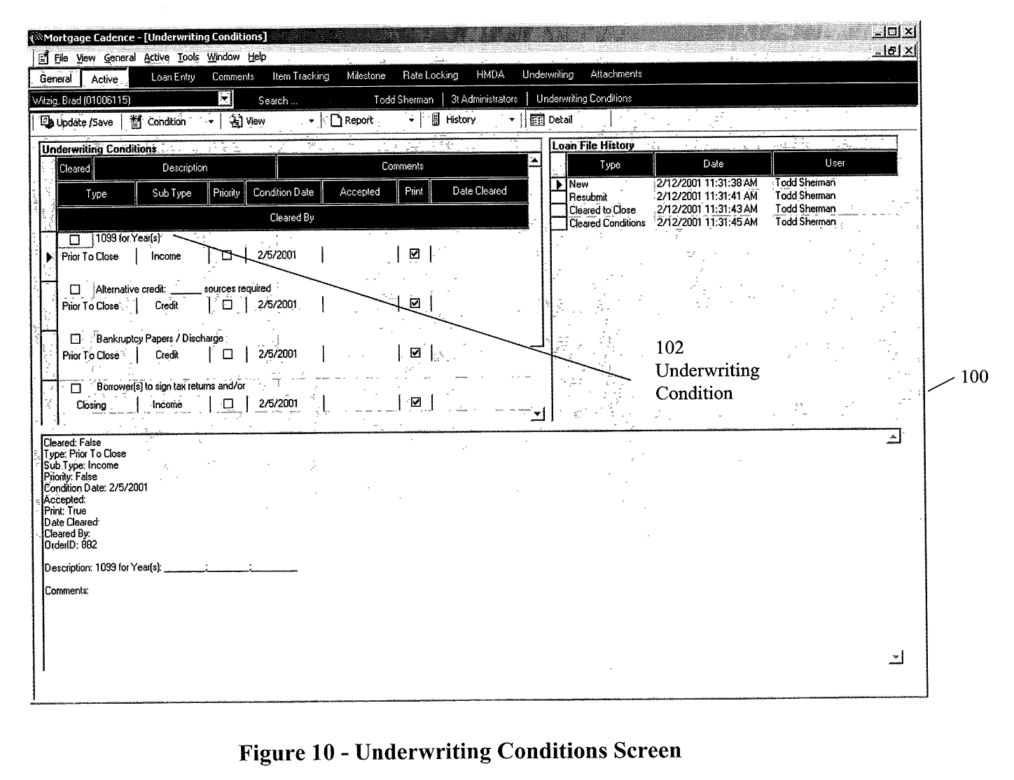

FIG. 10 depicts an underwriting conditions screen 100. The underwriting module allows underwriters to add conditions to a loan. For example, the underwriter may require 1099 tax form copies, as depicted by the underwriting condition 102 shown in FIG. 10, in order to grant the loan. The underwriting module may automatically assign a task to the department responsible for clearing a condition. Conditions may be selected from a master list, or a new condition may be added to the list. Conditions are added to the loan database and tracked by the invention. Users can check conditions as completed in this module. Conditions may be identified as private. The borrower may view conditions not identified as private. The underwriting module can print underwriter evaluation and loan suspension documents. The underwriting module may include a DU module that provides automated underwriting through DU (Desktop Underwriter). Desktop Underwriter is an underwriting system provided by Fannie Mae. Congress created Fannie Mae in 1938 to bolster the housing industry during the Depression. At that time, Fannie Mae was part of the Federal Housing Administration (FHA) and authorized to buy only FHA-insured loans to replenish lenders’ supply of money. In 1968, Fannie Mae became a private company operating with private capital on a self-sustaining basis. DU underwriting can be automated by the present invention and the underwriting request issued when a loan is placed into a specified status.

Similarly, the underwriting module may include an LP module that provides underwriting through LP (Loan Prospector). Loan Prospector is a software tool from Freddie Mac that supports underwriting. Freddie Mac is a stockholder-owned corporation chartered by Congress in 1970 to create a continuous flow of funds to mortgage lenders in support of home ownership and rental housing. Freddie Mac purchases mortgages from lenders and packages them into securities that are sold to investors. The LP underwriting process can be automated by the present invention and a request for underwriting produced in response to the loan being placed in a specified status.

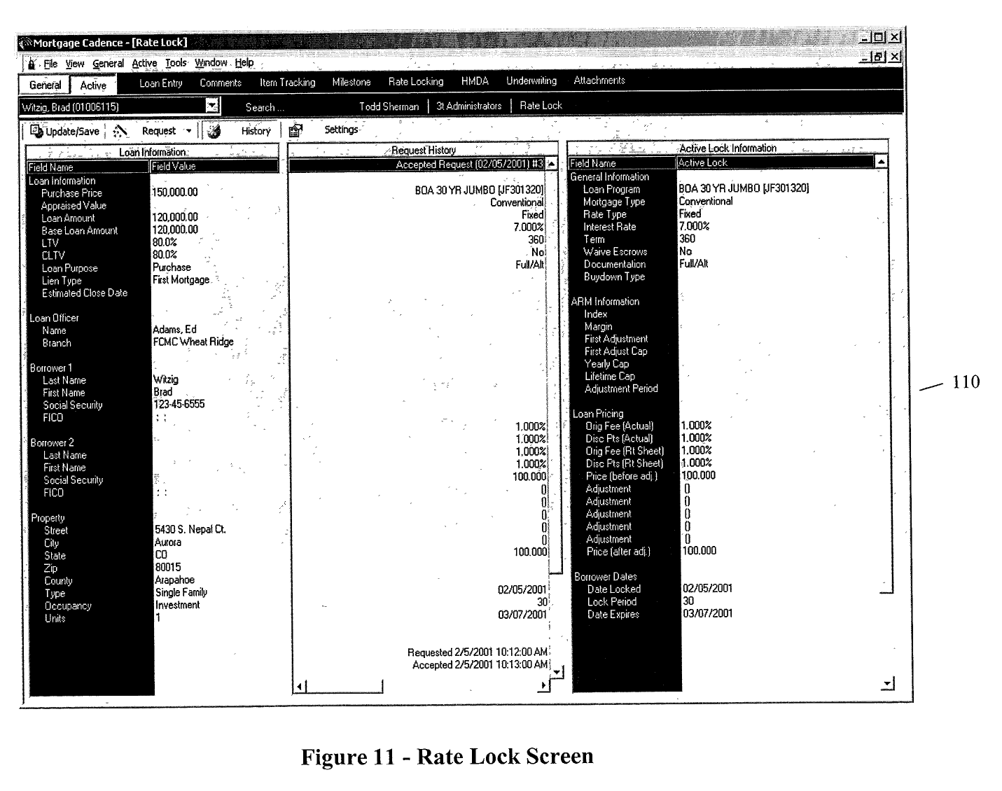

FIG. 11 depicts a rate lock screen 110. The secondary department of a mortgage company may lock the interest rate of a loan for a period of time. The rate lock screen allows the loan processor to view rate lock information. When an individual in the secondary department locks a rate for a loan, the rate lock module may send a tickler to the loan originator that the loan has been locked. Ticklers are further described below. The rate lock module supports rate locking requests, locking request acceptance, request rejections and lock cancellations.

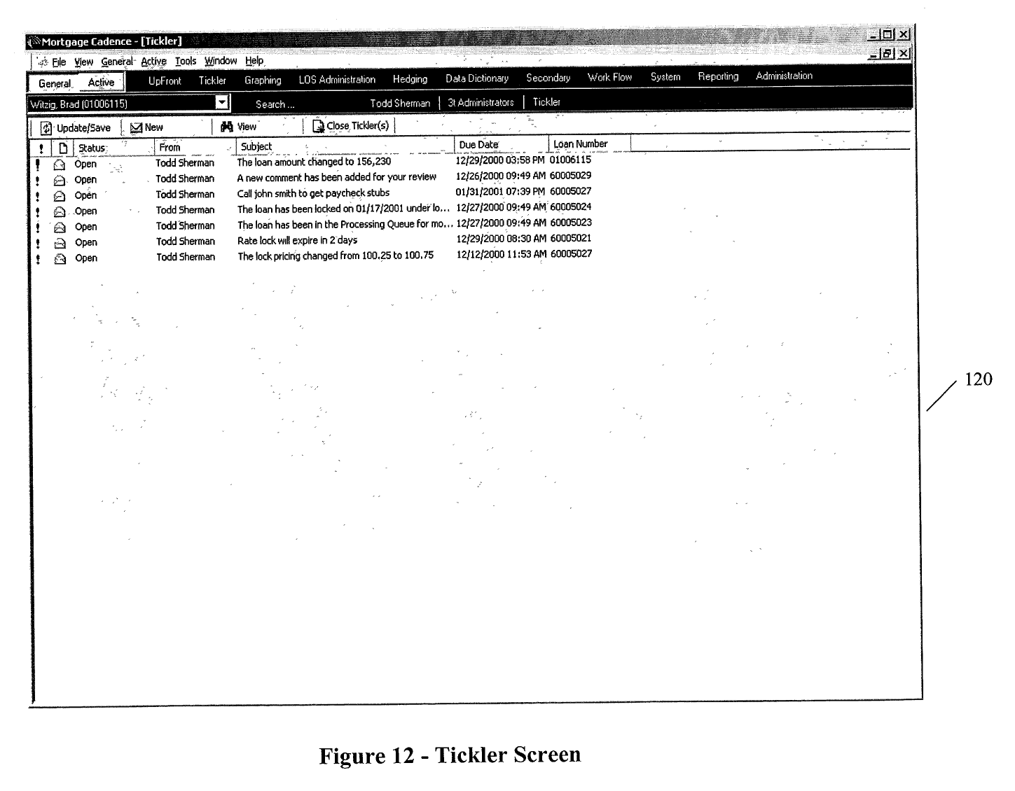

FIG. 12 depicts a tickler screen 120 of the present invention. The tickler module is an early warning notification and escalation system. Using the tickler module, key personnel may be quickly informed of upcoming events, critical loan field modifications, comments, other system or loan warnings, and user-created reminders. By alerting loan processors of delays or changes, the tickler module helps reduce loan processing time. Some examples of notifications are: loan has a comment addressed to a user, loan has user-created reminders, loan has been locked, or loan field has been changed or updated. Some examples of escalations are: loan has been in a “status” for too long, there are too many loans in a queue, or a critical date is about to expire (i.e. lock date). The example shows ticklers sent by Todd Sherman on a loan for Brad Witzig. The ‘open’ status of the ticklers indicates that the tickler messages are current.

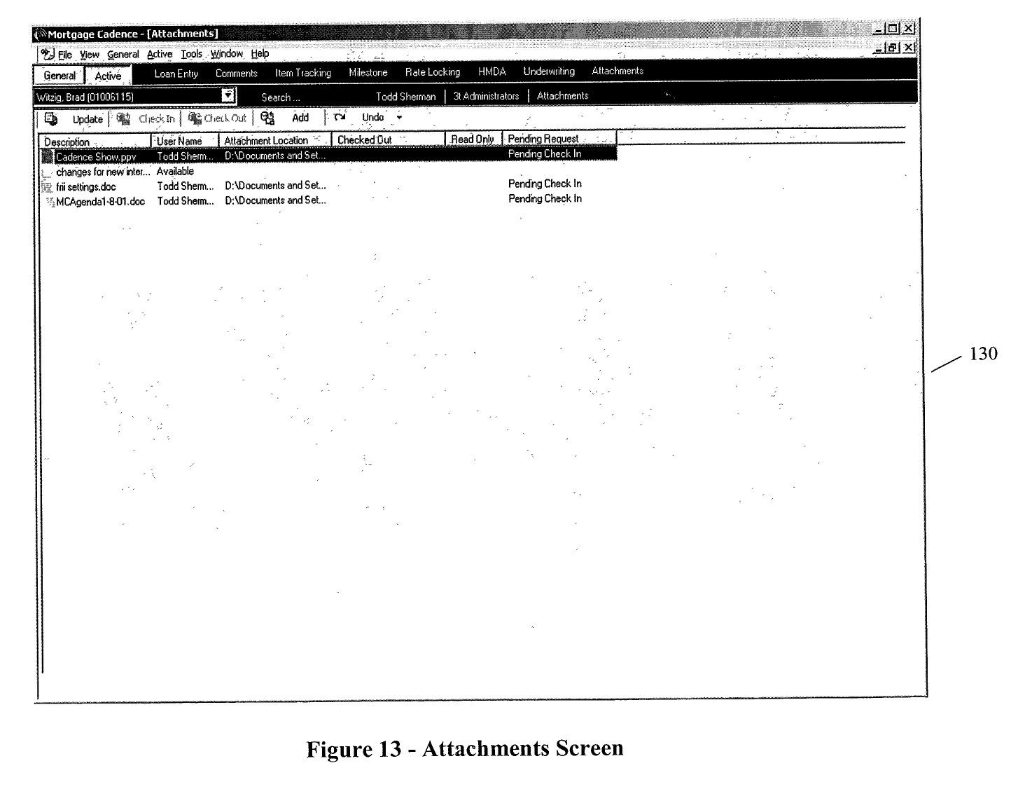

FIG. 13 is a depiction of an attachments screen 130. Attachments may be used to add additional information pertinent to the processing of a loan. For example, an attachment may contain a copy of a lease agreement for a property owned by the loan applicant. This information may be used to supplement income information in qualifying for a loan. The attachments module allows the user to attach a file to the loan database information. File types supported include any file that may be viewed through Microsoft Windows such as e-mail, text documents, scanned images, and word processor documents for example. One embodiment of the attachments module provides drag and drop file attachment such that the icon for the file is simply moved to an area in the attachment screen using a mouse and the mouse button released.

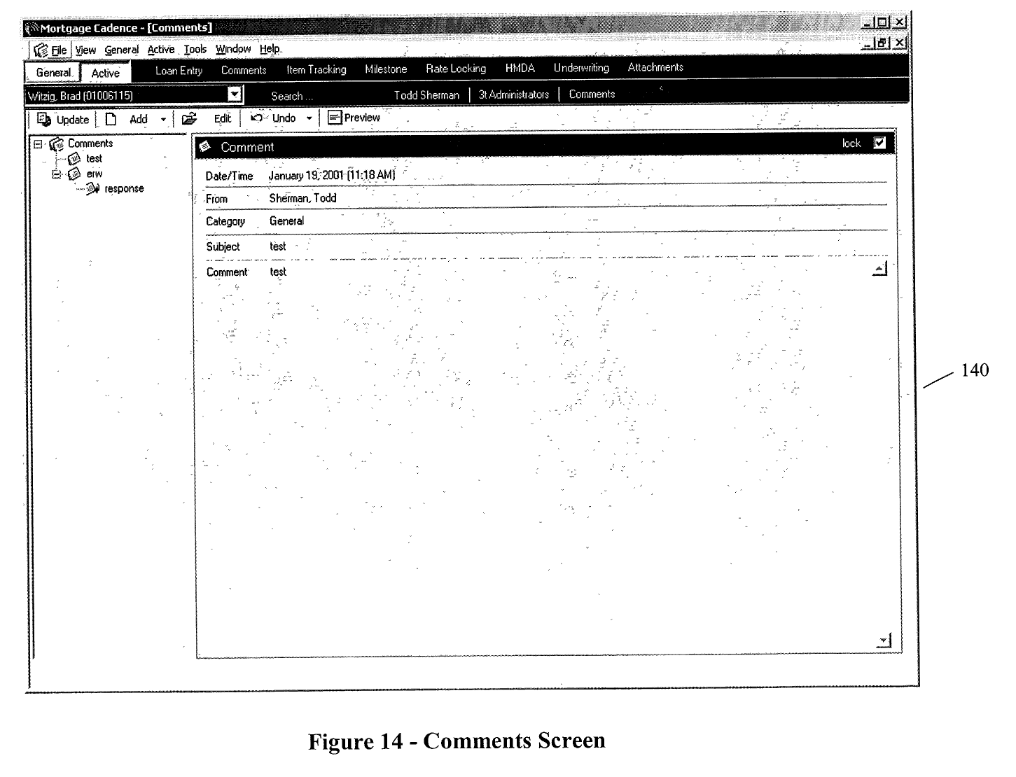

FIG. 14 is a depiction of a comments screen 140. Comments may be used to provide explanation of loan items. In contrast to the attachments screen 130 (FIG. 13) that is used for documents, the comments screen 140 is used for discourse when processing a loan. For example, a bad debt or late payment on a credit report may be further explained through comments. The comments module provides for comments to be assigned to individuals or departments as ticklers. Functions provided by the comments module include ‘read comments’, ‘add response to comments’, and the storing of comments and responses with loan information permanently in the database of the present invention.

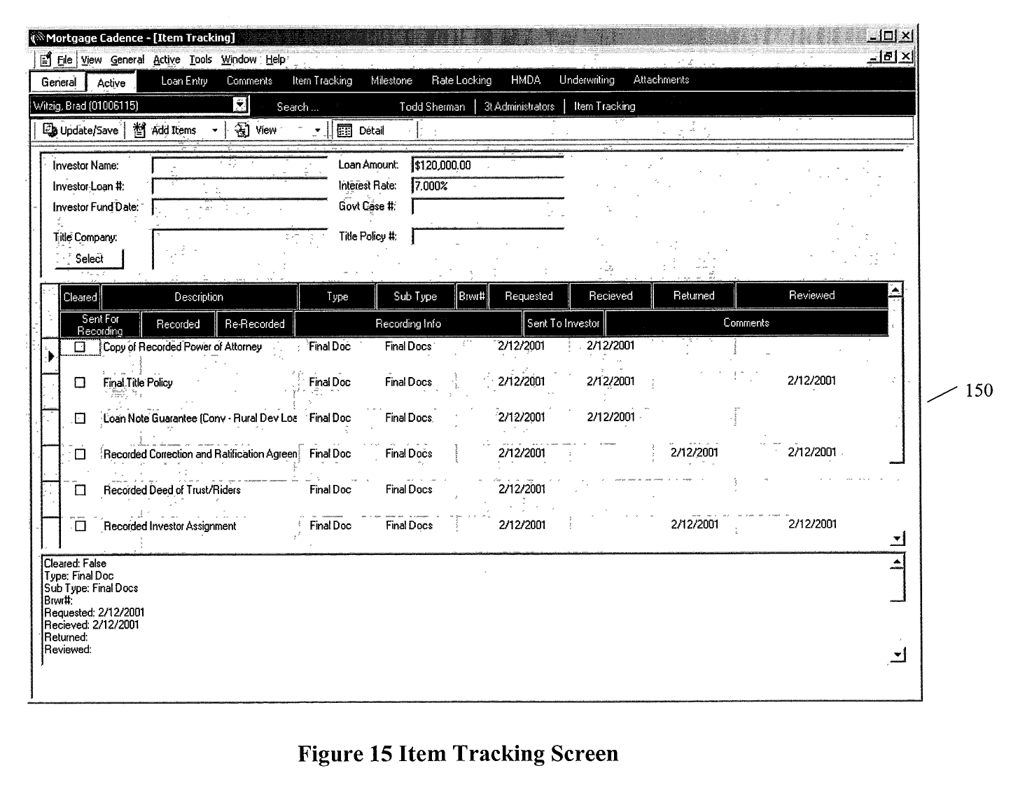

Referring to FIG. 15, the mortgage company tracks investor documents when a loan has closed such as title endorsement, recorded investor assignment, recorded deed of trust, recorded corrections, and mortgage insurance certificate, for example. The item tracking module allows such documents to be attached to loan information either manually or automatically based on criteria such as loan status and loan type for example. Items can be marked as completed through the item tracking screen 150 depicted in FIG. 15. A document module, not depicted, may be used to automatically order closing and post closing documents from FAND. First American Nationwide Documents (FAND) specializes in mortgage loan document preparation and electronic loan delivery services for the mortgage lending industry. Additionally, a file tracking module (not depicted) allows tracking of individual file locations after closing.

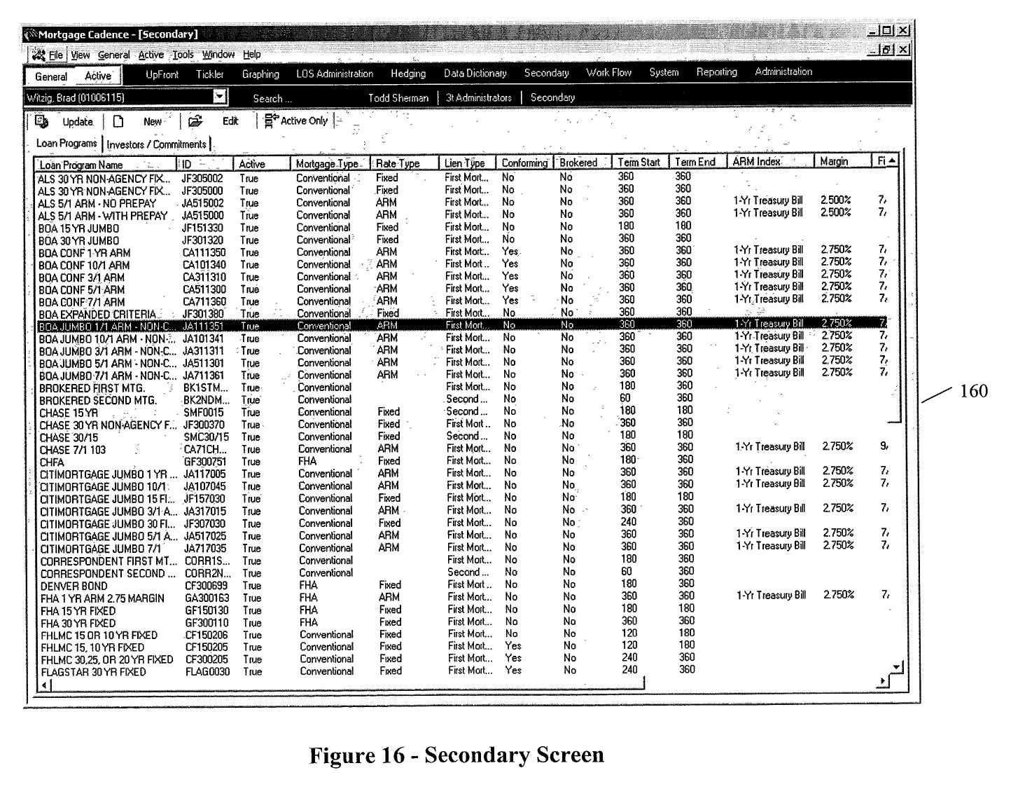

Referring to FIG. 16, mortgage lenders may provide loans to borrowers by establishing loan terms, and then selling the loan to banks and other financial institutions, termed investors, which actually supply the funds. Alternately, the mortgage company may lock a loan rate with an investor and then sell the loan to a borrower. The difference in interest rate between an investor loan and a mortgage loan creates a profit opportunity for the mortgage company. This method may also be used to exchange up front costs for a slight increase in interest rate. For example, a mortgage company may advertise that there are no loan origination fees, and then the actual cost of originating the loan is recouped in the interest rate difference between the investor rate and the loan rate. The department of the mortgage company that deals with establishing loan interest rates from investor interest rates is termed a secondary department. FIG. 16 depicts a secondary screen 160 containing investor information. From this information, a loan administrator may set internal loan interest rates for various types of loans (i.e. FHA or conventional, Fixed or ARM, etc.) from various investors. The secondary module stores information about the various loans, called a loan program, which may be imported from a spreadsheet application such as Excel. The secondary module also allows rate sheet maintenance and entry, investor entry, and entry of investor commitments.

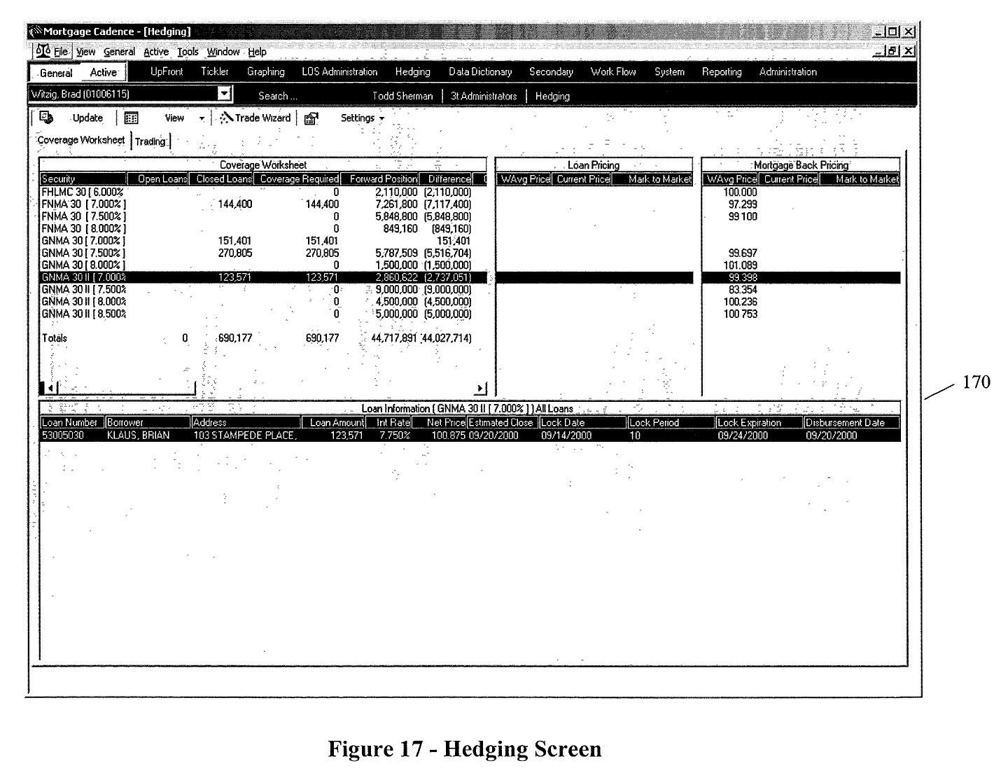

If the mortgage company locks a loan at a specific interest rate, and the rate at which investors supply funds subsequently changes, the mortgage company may be at risk to lose money or have reduced profit. The mortgage company may buy insurance for locked loans, an activity called hedging. FIG. 17 depicts the hedging screen 170 that tracks loans for which insurance has been purchased. The hedging module also allows tracking of loans for which insurance is being considered. Loans may be placed into consideration automatically through predefined criteria such as interest rate spread. The hedging module also supports trade tracking, loan slotting into securities, and loan pricing.

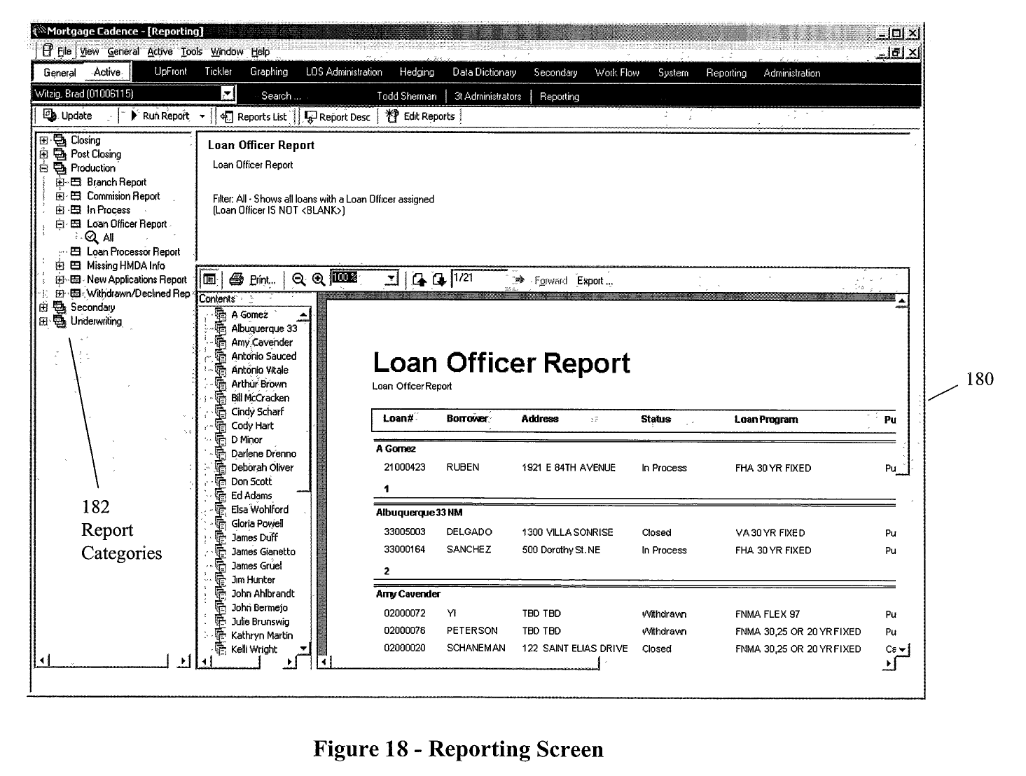

Referring to FIG. 18, management of a mortgage company involves tracking performance of many variables. The reporting module of the present invention provides user defined reports that may be generated automatically or upon request. The reporting screen 180 depicted in FIG. 18 shows an officer report as may be generated by the invention. The reporting screen shows report categories 182. The user can select a report category, then select a report type from that category and then select ‘run’ to produce a preview of a report. The reporting module contains a group function such that a report may be produced for a set of loans identified by some criteria such as loan processor, data of loan, and type of loan, for example. Operationally, the user selects the group function and then selects criteria from a selection menu. The user may save a set of criteria used for a report for use in future reports. The user may define new reports and save the report definition under a new entry in report categories 182, or as a new type of one of the categories.

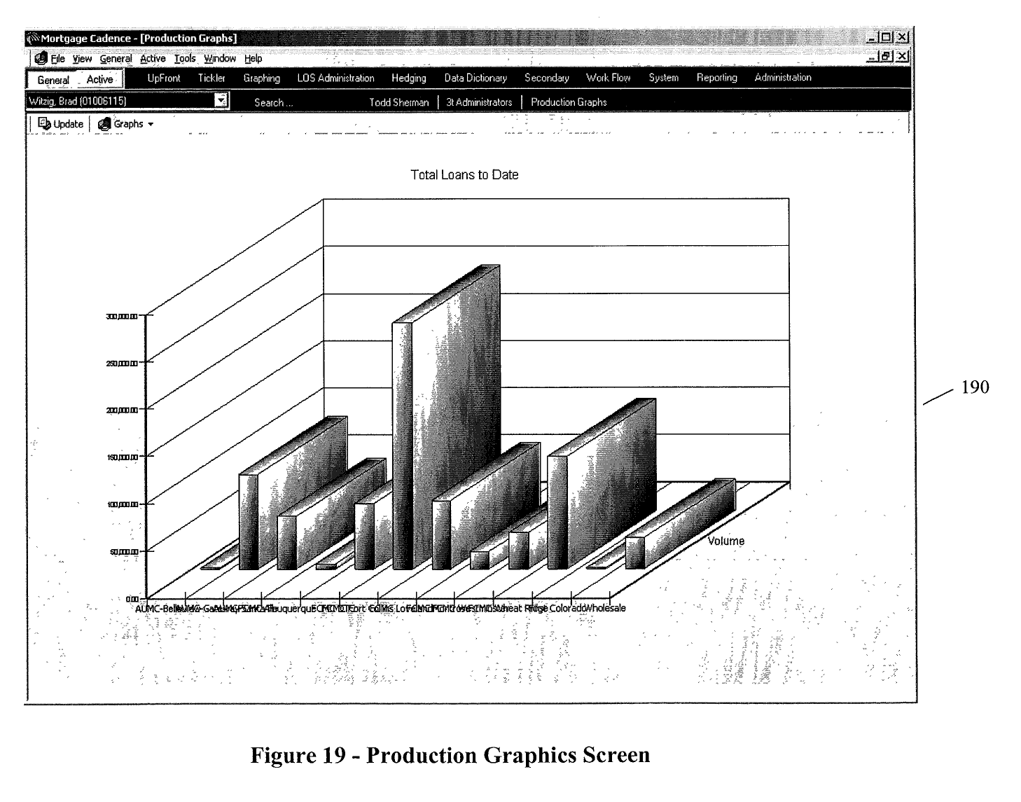

Report information, such as trends, may be more advantageously displayed in graphical formats. FIG. 19 depicts a production graphics screen 190.

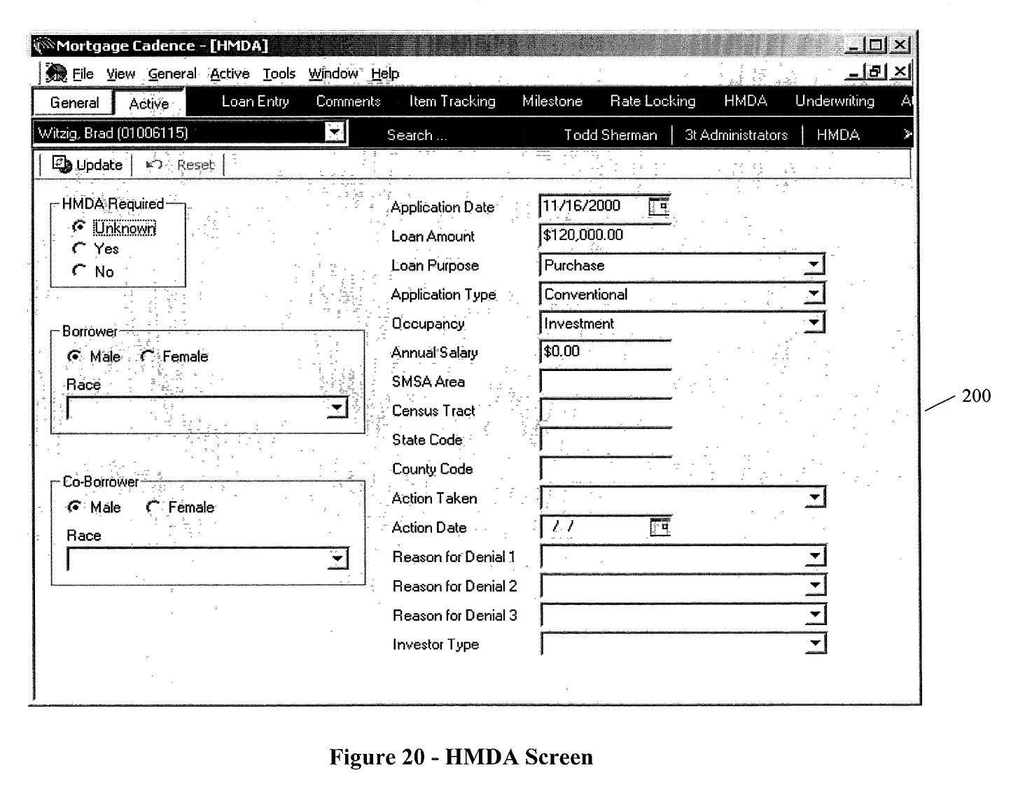

FIG. 20 depicts an HMDA (Housing Mortgage Disclosure Act) screen 200. All standard HMDA information may be entered on this screen. The HMDA module may automatically retrieve geo-coding information. All banks and mortgage companies held by banks or processing over 100 loans per year, must submit HMDA reports of all of their loans to the Federal government. Information entered on HMDA screen 200 may include names of the borrower and co-borrower, whether they are male or female, and the race of the borrower (if provided), the loan amount, loan purpose, census areas, and reasons for denial if the loan was denied. This information is reported to the government on a yearly basis. The HMDA reporting module may be used to submit information to a reporting agency. The HMDA and HMDA reporting modules simplify the collection and dissemination of governmentally required information.

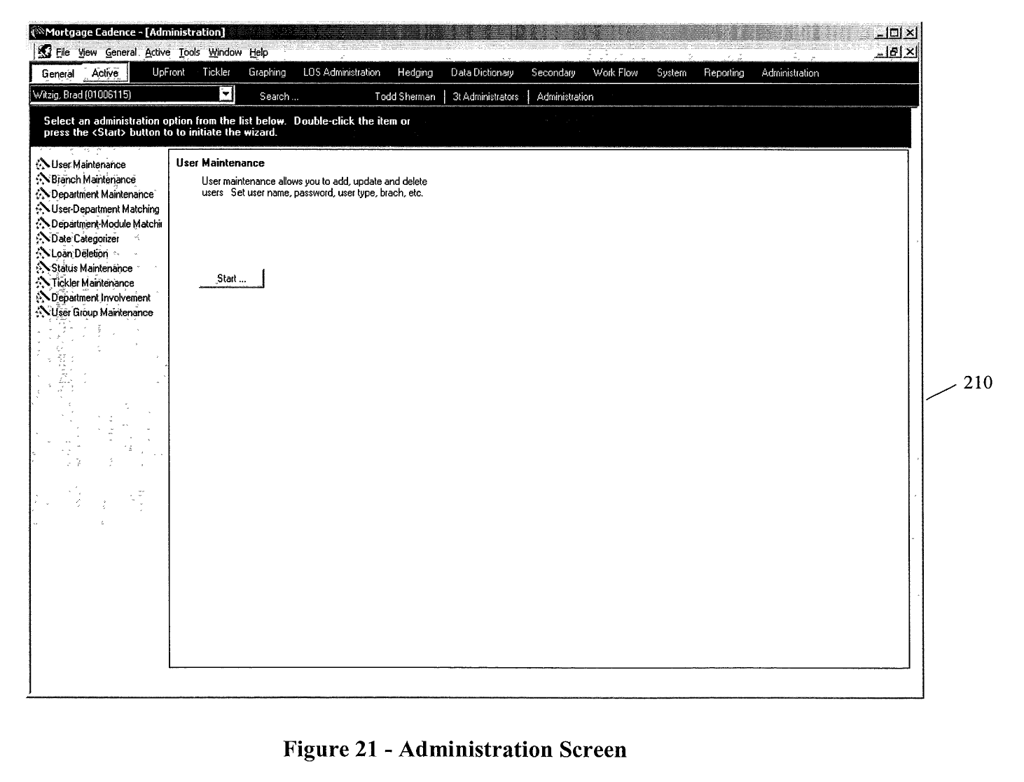

The present invention provides administrative functions that allow management and customization of various aspects of the invention. FIG. 21 depicts an administration screen 210. Through a set of provided functions of the present invention, the administrator may add or delete users, may define which modules are provided for specific user types, or perform other actions. A branch maintenance function allows the administrator to enter new branches into the system. A department maintenance function allows the administrator to add departments such as underwriting, originating, and processing, for example. A user department matching function allows the administrator to associate users with departments. Users may be in more than one department. A department module matching function allows the administrator to specify by department, which modules that users in that department are allowed to access. The administration module may also be used to access functions for data maintenance (such as server data backup), module maintenance and to specify loan number formats. A commissions module (not depicted) allows commissions to be calculated by criteria such as loan value or profitability, for example.

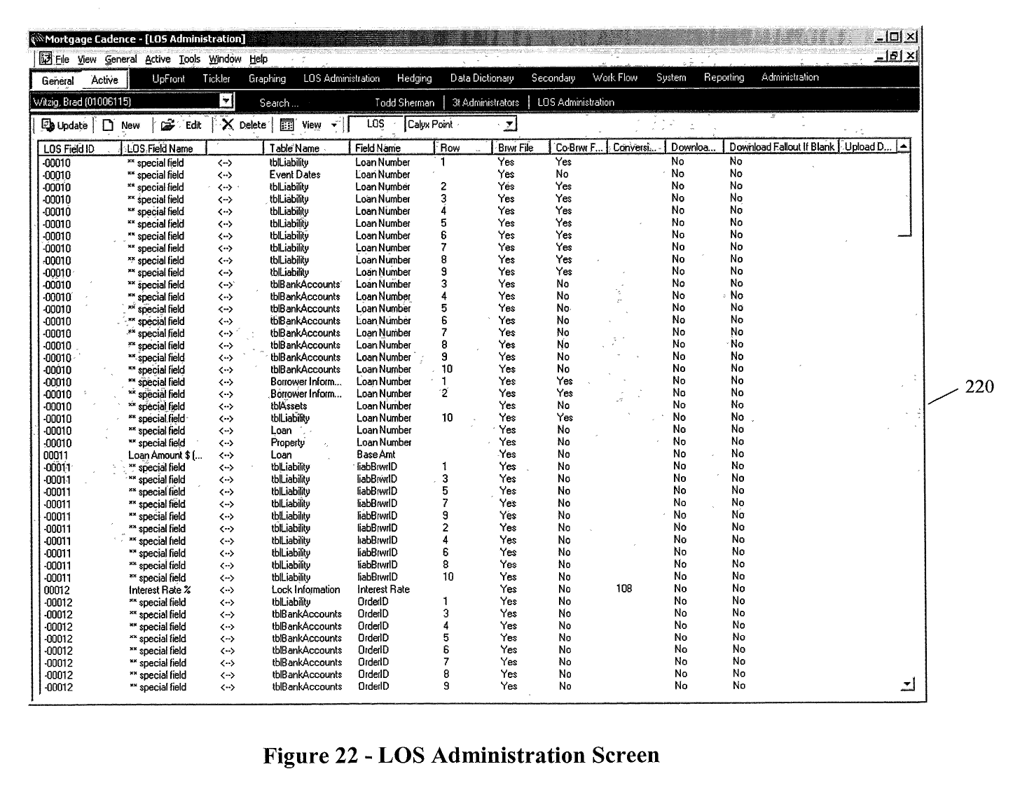

FIG. 22 is a depiction of an LOS administration screen 220. This screen illustrates the capability of the present invention to map the data from third party LOS products to the database of the invention. The figure shows data types for Calyx Point and Contour LOS products. The mapping of fields of data between a specific LOS product and the database of the present invention is defined through a field mapping module (not depicted). The field mapping module also specifies rules under which a loan originator may ‘check-out’ a loan to add additional information and then ‘check-in’ the loan. The check-out and check-in process limits access by others to loan information when information is added or updated by the loan originator, to insure that individuals processing a loan have up-to-date information.

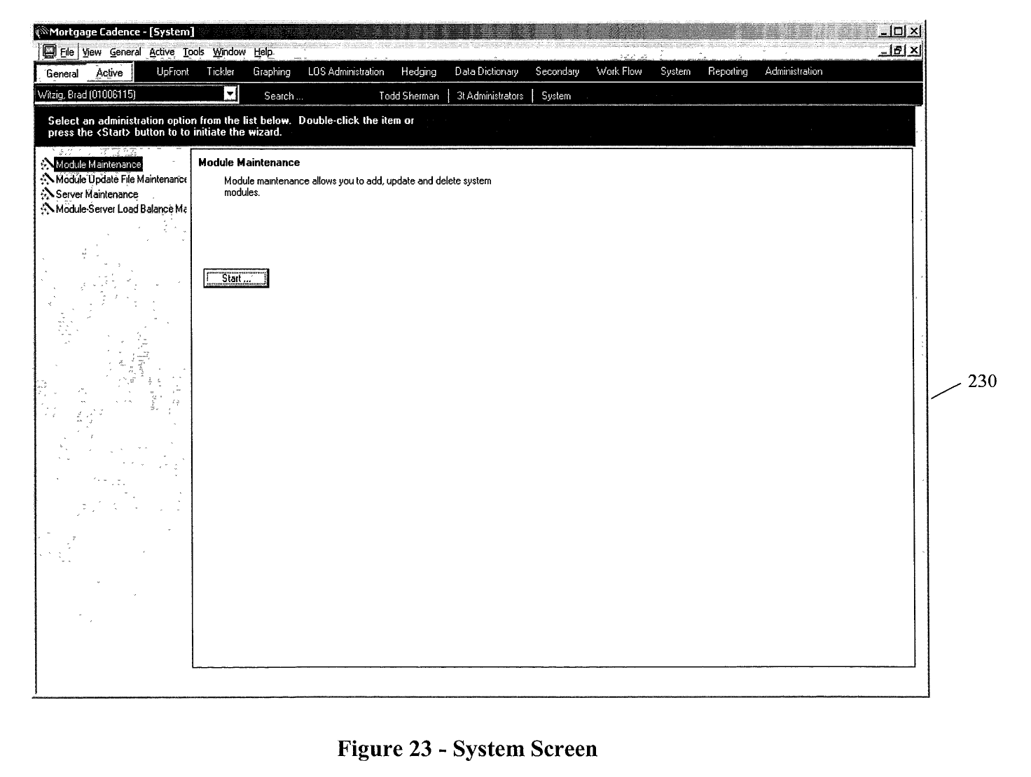

FIG. 23 depicts a system screen 230 that illustrates the module maintenance features of the invention, allowing modules to be added, updated, or deleted. The system module is for high level technical users, such as system administrators, and network administrators, for example. It is through the system screen that module maintenance may be performed. The system module allows definition of which modules are available in the system, and also allows the administrator to specify associate files that need to be downloaded with a module. Additionally, the system module allows the administrator to perform server load balancing, where processes are distributed across multiple servers, depending on server workload, to provide higher server utilization and higher application execution speed.

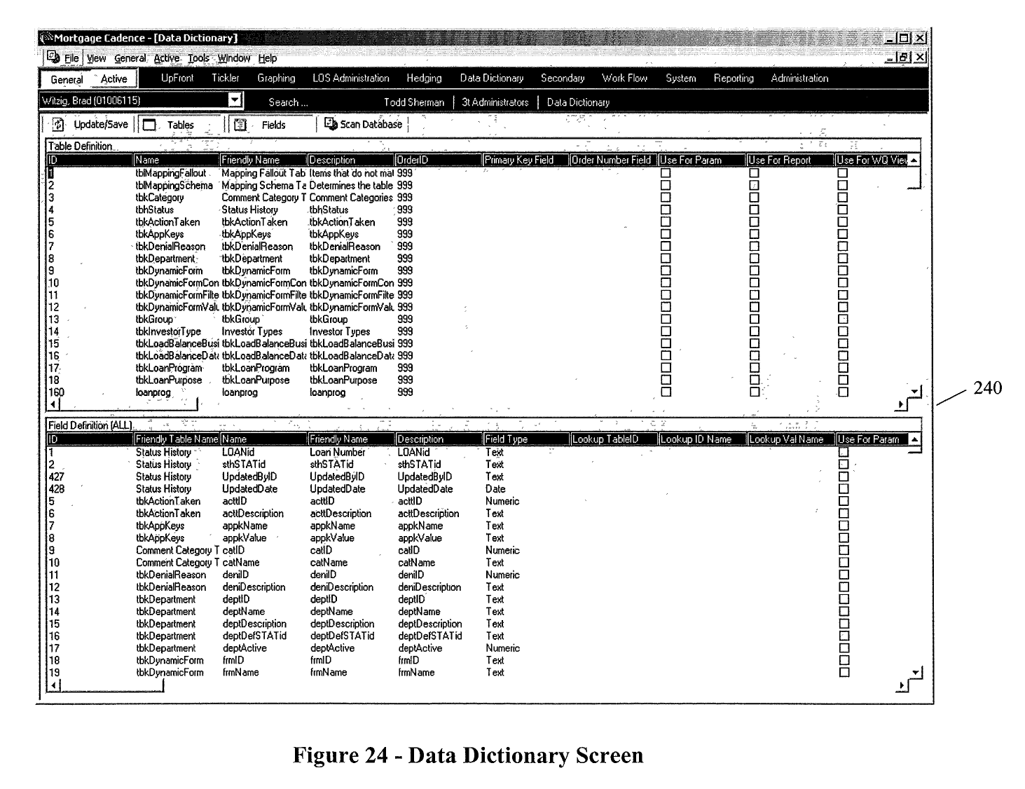

FIG. 24 depicts a data dictionary screen 240. The data dictionary provides field and table definitions and parameter names to simplify modification of existing modules or generation of new modules. The data dictionary also allows users to specify search fields and allows users to define labels for each loan field.

The invention provides modules containing functions that may be enabled automatically or manually. A credit module may order a credit report from a credit agency and enter received information to the loan database. Credit reports may be automatically ordered when the loan is placed into a specified status. Similarly, an appraisal module may order electronic appraisals and such ordering may be in response when the loan is placed into a specified status. Further, a flood report may be ordered through the system of the invention and such ordering may be performed automatically in response to when the loan is placed in a specified status. Yet further, ordering of a title policy may be performed by the system of the invention and such ordering of the title to policy may be automatically performed when the loan is placed in a specified status.

A pocket Cadence module provides operation of the client application or portions thereof on small portable or laptop computers. The pocket cadence module capabilities include display of a upfront screen, loan application quick entry, that may be as short as the borrower's social security number and address of the property, a loan application print function and a function that prints good faith estimates of loan costs.

The invention provides a tickler module that provides automated signaling to individuals that an event that is important in processing the loan has occurred or is about to occur. The tickler module acts as an early warning, escalation and notification system. Prior to the occurrence of the event (which may be a date or a loan status), tickler status has a value of ‘pending’. Once the event occurs, the tickler status changes to a value of ‘open’. A tickler status of ‘open’ is a call to action. Upon completion of the tickler item, the tickler status is changed to ‘closed’. The tickler module provides for simplified creation, definition and deletion of tickles. Users may list all tickles by type or status. A tickler may be a personal tickle, such that a user may define an event and then have that event produce a tickler to that user. A tickler may be assigned to another user. Tickles may be closed, updated or postponed to a later date or loan status. Tickle types include personal, rate lock, comment, and escalation. A rate lock or a rejected rate lock can automatically provide a tickler to the loan originator and the loan processor. A comment may provide a tickler to the recipients. The escalation feature of the tickler module provides a set of circumstances that may be selected from (or added) to create a tickle. Examples of the set of circumstances are:

a. “date” is about to expire

b. “date” is complete but a “field” or “status” is not complete

c. loan has been in a status too long

d. task has not been completed in a specified time period

e. loan has been in this queue too long

f. status=“some status”

g. loan is in this status but this “field” or “date” is blank

h. loan is locked but no loan program

The tickler module reduces loan processing time to close a loan by giving users the ability to communicate with and request important information from specific individuals.

In the preferred embodiment of the invention, server components comprise Microsoft SQL server 2000. The client application (Client Shell) runs under Windows 98 or Windows 2000 as a Microsoft Windows 32 bit MDI application employing only one Child Form. Multiple instances of the Client Form can be loaded into the Client Shell. Each instance of the Child Form can load one dynamic module (ActiveX control). This architecture allows new functionality to be added to the client by providing a new module that may be loaded by the Child Form without recompiling. Each module is a display element for user interaction. The client application communicates with the server through the Internet using HTTPS protocol. This communication employs SSL (Secured Socket Layer) for all data communications with SSL Certificate(s) on the server. Software modules are developed using Visual Basic. Other software tools may be used.

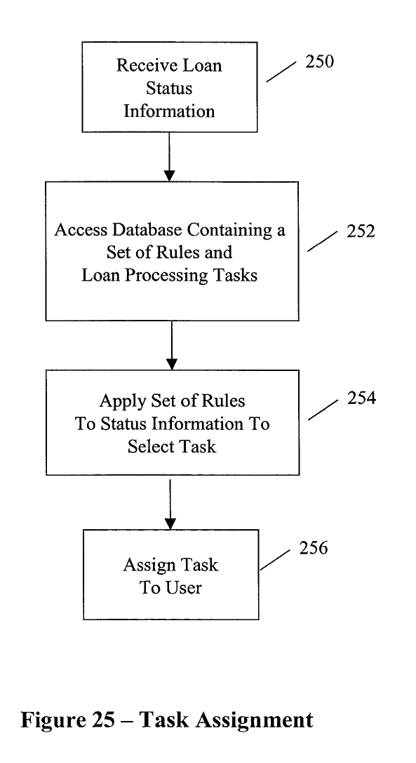

FIG. 25 depicts one embodiment of task assignment. At step 250, loan status information is received. Loan status information may indicate a number of conditions associated with processing a loan including a new loan application, completion of a previously assigned task, acceptance of a task by a user, occurrence of a time or date, existence of a message or messages, or other conditions as described in previous figures. At step 252, a database containing a plurality of loan processing tasks and a set of rules is accessed. At step 254, the set of rules are applied to the status information to select at least one task of the plurality of loan processing tasks. At step 256, the at least one task is assigned to user.

In the aforedescribed manner, the present invention provides a new system and method through which loans may be processed quickly and efficiently. The status driven nature of the present invention allows the status of a loan to be quickly determined without interrupting workers or incurring delays in determining the whereabouts of desired information. The automated determination of the status of a loan and the actions that are to be taken in completing loan processing, plus the automatic assignment of these actions, provide a closed loop process, reducing or eliminating loose ends associated with manual processing of loans and saving the time and expense incurred in determining the status of a manually processed loan. The database of the present invention allows all to information associated with a loan to be stored in electronic format. The tracking functions provide review of processing actions, allowing performance appraisal. The flexible nature of the present invention, including module creation, editing and assignment of tasks to particular individuals or groups, allows the invention to be employed in a range of companies that vary in size and method of loan processing.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for processing a loan employing a database containing a plurality of tasks and a set of rules associated with processing a mortgage loan comprising:
receiving mortgage loan status information;
accessing said database containing said plurality of tasks and said set of rules;
employing said set of rules to associate said status information with at least one task of said plurality of tasks; and
assigning said at least one task to a user.

2. The method of claim 1, wherein said step of receiving status information further comprises:
transferring said status information across a network.

3. A method for processing a loan employing a database containing a plurality of tasks associated with processing a mortgage loan comprising:
receiving status information;
accessing said database containing a plurality of tasks associated with processing a mortgage loan;
employing a set of rules to associate said status information with at least one task of said plurality of tasks;
assigning one of said at least one task to a first queue in response to said status information; and
assigning said at least one task to a second queue if selected by a user.

4. A method for processing a loan employing a database containing a plurality of tasks associated with processing a loan comprising:
receiving first status information;
accessing said database containing a plurality of tasks associated with processing a mortgage loan;
employing a set of rules to associate said first status information with a first task of said plurality of tasks;
assigning a first task of said plurality of tasks to a first user;
receiving second status information;
employing said set of rules to associate said second status information with a second task of said plurality of tasks; and
assigning said second task of said plurality of tasks to said user.

5. The method of claim 4 wherein said step of receiving second status information further comprises:
checking a permission value associated with said second status information.

6. A method for managing work employing a database containing a plurality of tasks comprising:
receiving first status information;
accessing said database containing a plurality of tasks;
employing a set of rules to associate said first status information with at least one task of said plurality of tasks;
associating said first status information with said at least one task;
assigning said at least one task to a user;
assigning second status information to said at least one task in response to a user input; and
changing at least one element of said second status information to indicate completion of part of said task.

7. A method for processing a loan employing a database comprising:
receiving loan request information;
checking if said loan request information includes a social security number;
checking if said loan request information includes a property address;
checking if said loan request information includes an income amount; and creating a loan application database entry containing said social security number, a property address and an income amount if said social security number, property address and income amount are included in said loan request information.

8. A method for processing a loan employing a database containing a plurality of tasks associated with processing a mortgage loan comprising:
entering loan information into said database;
processing said loan information using a set of rules to produce a status result; and
automatically electronically acquiring information from a third party if said status result equals a predetermined value.

9. The method of claim 8 wherein said third party is a credit reporting company.

10. The method of claim 8 wherein said third party is a title company.

11. The method of claim 8 wherein said third party is a federal agency providing flood information.

12. The method of claim 8 wherein said step of entering data further comprises:
establishing a network connection.

13. The method of claim 12 wherein said network connection employs security coding.

14. A method for processing a loan employing database comprising:
entering loan information into said database;
processing said loan information using a set of rules to produce a status result; and
disseminating said data to an agency if said status result equals a predetermined value.

15. The method of claim 14 wherein said step of disseminating includes organizing said data in accordance to a predefined form.

16. The method of claim 14 wherein said step of disseminating further comprises establishing a network connection.

17. The method of claim 16 wherein said network connection employs security coding.

18. A method for processing a loan employing a database comprising:
receiving loan request information including property location;
comparing said property location with flood data in said database; and
automatically ordering a flood report if said property location lies within a flood area.

19. The method of claim 18 wherein said step of ordering further comprises:
establishing a network connection.

20. A method for processing a loan employing a database comprising:
receiving a loan request;
receiving property information including a property appraisal value; and
automatically creating an electronic message if said property appraisal value is less than or equal to a predetermined value stored in said database.

21. A method for managing work employing a database comprising:
receiving an electronic message sent to a first user;
storing said message in said database;
assigning a first status to said message;
assigning a second status value to said message if said first user does not respond to said message within a predetermined time period; and
sending said message to a second user.

22. A method for processing a loan employing a database comprising:
receiving a loan request including loan amount;
storing said loan amount in said database;
receiving an appraisal value;
storing said appraisal value in said database; and
automatically creating an electronic message if said loan amount is greater than or equal to a predefined percentage of said appraisal value, said predefined percentage being stored in said database.

23. A method for processing a loan employing a database comprising:
receiving a loan request including a loan amount;
storing said loan amount in said database;
receiving an appraisal value;
storing said appraisal value in said database; and
automatically placing an underwriting condition on said loan if said loan amount is greater than or equal to a predefined percentage of said appraisal value, said predefined percentage being stored in said database.

24. A method for processing a loan employing a database containing task information comprising:
entering loan application information into said database;
creating a first status value if said loan application information contains a predefined set of information;
assigning a first loan processing task if said first status value is not in agreement with a stored status value; and
assigning a second loan processing task if said first status value is in agreement with said stored status value.

25. A method for managing work employing a database comprising:
receiving an electronic message from a first user directed to a second user;
storing said message in said database;
assigning a first status value to said message;
assigning a second status value to said message if a response to said message is entered; and
assigning a third status to said message if a response is not received in a predetermined amount of time, said predetermined amount being stored in said database.

26. A method for processing a mortgage loan employing a database comprising:
opening a graphical user interface containing a file attach function area displayed within said user interface;
selecting a file containing mortgage loan information using a pointing device;
moving a file icon associated with said file to said file attach function area;
receiving a user input; and
storing said file in said database and associating said file with a loan number.

27. A method for processing a loan employing a database containing task descriptions comprising:
entering loan information into said database;
processing said loan information to select a first task;
assigning a status value to said first task;
performing said first task;
changing said status value in response to user input; and
assigning a second task in response to said change in said status value.

28. The method of claim 27 wherein said step of changing said status value further comprises:
storing information describing said status value, user identification information, and date in said database.

29. A method for processing a loan employing a database containing task descriptions comprising:
entering loan information into said database;
placing a loan processing task in a first task queue in response to said loan information;
assigning a first status value to said loan processing task;
placing said task in a second task queue in response to user input; and
assigning a second status value to said loan processing task.

30. A method for processing a loan employing a database comprising the steps of:
entering loan information using a first loan origination software program;
receiving said loan information at a server;
formatting said loan information;
storing said information in said database;
receiving a request for information from a second loan origination software program;
retrieving information from said database;
formatting retrieved information for said second loan origination software product to produce formatted information; and
transferring said formatted information to said second loan origination software product.

31. The method of claim 30 wherein said step of receiving a request further comprises:
inhibiting other users from accessing said information.

32. A method for supplying a loan number for a loan employing an Internet connected server comprising the steps of:
entering loan request data using a first software program;
connecting to said server using a second software program;
transferring said loan request data from said first software program to said second software program;
transferring said loan request data from said second software program to said server;
determining a loan number in said server; and
transferring said loan number from said server to said second software program.

33. A method for managing work employing a database containing task information comprising:
receiving data;
processing said data using a set of rules to produce a status result;
storing said status result in said database;
assigning a first task to a first task queue based on said status result;
moving said first task from said first queue to a second task queue in response to a user input;
receiving status update information;
producing an updated status result using said status update information; and
assigning a second task to a third task queue based on said updated status result.

34. An automated loan processing system comprising:
a database containing loan information, a plurality of loan processing tasks, status information and a set of rules;
a client software program comprising at least one software module that may be dynamically loaded;
a server loan processing software program operable to apply said set of rules to said status information to assign at least one task of said plurality of loan processing tasks to a user; and
a network connection that provides communication between said server and a client computer.

35. The system of claim 34 wherein said client program is a Windows 32 bit MDI application with only one child form.

36. The system of claim 34 wherein said client program contains multiple instances of said only one child form.

37. The system of claim 34 wherein said client software program is operable on a pocket computer and contains loan application functions and functions to print a loan application and a good faith estimate.

38. The system of claim 34 further comprising:
a module development software program that allows an additional loan processing task to be added to said database.

39. The system of claim 34 further comprising:
a module development software program that allows an additional loan processing rule to be added to said set of rules in said database.

40. A system for processing a loan comprising:
a database containing loan information and plurality of loan processing task descriptions;
a plurality of first software programs, each providing a function associated with processing said loan;
a second software program operable to detect a variable contained in one of said plurality of first software programs and to transfer one of said plurality of task descriptions to said one of said first plurality of software programs based on the value of said variable.

41. The system of claim 40 further comprising:
status information stored in said database, wherein said second program is operable to read said status information and transfer one of said plurality of task descriptions to one of said plurality of first software programs based on said status information.

42. The system of claim 40 further comprising:
a network interface operable to transfer variables and status information to said database.

43. A system for processing loans comprising:
a server;
a database contained in said server comprising loan processing tasks, loan information and loan processing status information;
a plurality of software function modules; and
a software program operable to conditionally transfer a task to one of said plurality of software function modules based on said loan processing status information.

44. The system of claim 43 further comprising:
a software routine operable to detect a change in a variable contained in one of said plurality of software function modules and to transfer a task to another one of said plurality of software function modules in response to said change in a variable.

45. The system of claim 43 further comprising:
a software routine operable to detect a change in said loan processing status information and to transfer a task to one of said plurality of software function modules in response to said change in a said loan processing status information.

46. The system of claim 43 further comprising:
a software routine operable to detect a change in a variable contained in one of said plurality of software function modules and to issue a message to another one of said plurality of software function modules in response to said change in a variable.

47. The system of claim 43 further comprising:
a software routine operable to detect a change in a said status information and to issue a message to one of said plurality of software function modules in response to said change in said status information.

48. The system of claim 43 wherein said software program is responsive to interrupts from said plurality of software function modules.

49. The system of claim 43 wherein said software program checks variables in each of said plurality of software function modules in a predetermined order.

50. The system of claim 43 wherein said plurality of software function modules contain a plurality of sets of variables wherein one set of each said plurality of sets of variables is associated with one loan.

51. The system of claim 50 wherein said software program processes each set of variables of said plurality of sets of variables for one software function module of said plurality of software function modules before processing variables from another one of said plurality of software function modules.

52. The system of claim 50 wherein said software program processes a first set of variables of said plurality of sets of variables for one software function module of said plurality of software function modules and then processes a second set of variables from another one of said plurality of software function modules wherein said first set of variable and said second set of variable are associated with one loan.
